(19) United States
(12) Patent Application Publication
(10) Pub. No.: US 2009/0229766 A1
(43) Pub. Date: Sep. 17, 2009

(54) ADHESIVE REMOVAL DEVICE

(76) Inventors: Jason L. Aveldson, Prior Lake, MN (US); Eric R. Cybulski, Woodbury, MN (US); Jay A. Esch, River Falls, WI (US); Scott D. Gullicks, Apple Valley, MN (US); Robert A. Harkins, Savage, MN (US); Erik J. Johnson, Oakdale, MN (US); Steven G. Lucht, Inver Grove Heights, MN (US); Audrey A. Sherman, St. Paul, MN (US); Wendi J. Winkler, Minneapolis, MN (US)

Correspondence Address: 3M INNOVATIVE PROPERTIES COMPANY, PO BOX 33427, ST. PAUL, MN, 55133-3427, US

(21) Appl. No.: 12/401,847

(22) Filed: Mar. 11, 2009

Related U.S. Application Data
(60) Provisional application No. 61/036,683, filed on Mar. 14, 2008.
(60) Provisional application No. 61/100,428, filed on Sep. 26, 2008.

(51) Int. Cl. B29C 63/48

(52) U.S. Cl. 156/584

(57) ABSTRACT

An adhesive removal system useful for removing a stretch release adhesive from a component includes a first member that engages with a component and an adhesive removal member that moves the adhesive and component relative to each other in order to stretch the adhesive and release the adhesive from a bond surface of the component. In some embodiments, the adhesive removal member applies a substantially uniform pulling force across the adhesive. The adhesive removal member may be manually actuated by a user or with the aid of an automated device. In some embodiments, the adhesive removal system comprises a rotatable portion that moves the adhesive relative to the component. In other embodiments, the adhesive removal system includes features that enable the first member and a second member, which is mechanically coupled to at least a portion of the adhesive extending from the component, to move relative to each other.

### CROSS REFERENCE TO RELATED APPLICATION

This application claims the benefit of U.S. Provisional Patent Application No. 61/036,683, filed Mar. 14, 2008, the disclosure of which is incorporated by reference herein in its entirety and U.S. Provisional Patent Application No. 61/100,428, filed Sep. 26, 2008, the disclosure of which is incorporated by reference herein in its entirety.

### TECHNICAL FIELD

The present disclosure relates to adhesive, and, more particularly, to removal of adhesive from a substrate to which the adhesive is bonded.

### BACKGROUND

Some adhesives comprise stretch release properties that enable the adhesive to be detached from a substrate to which it is bonded by stretching the adhesive. In some cases, the stretch release adhesive may be stretched at an angle relative to the bond surface of the substrate in order to release the adhesive from the surface. Many stretch release adhesives, once bonded to a substrate, are relatively cleanly removable from the substrate, such that there is no visible residue remaining on the substrate and no visible damage to the substrate. Stretch release adhesives tapes are useful in a variety of applications including, but not limited to, assembling, joining or attaching elements of a component or mounting a component to a surface.

### SUMMARY

In general, the present disclosure is directed toward systems and methods of removing an adhesive from a component (also referred to as a “substrate”), where the adhesive exhibits stretch release properties. An adhesive removal system may include a first member that engages with the component, where a layer of stretch release adhesive is bonded to at least one surface of the component, and an adhesive removal member that moves the adhesive and component relative to each other in order to stretch the adhesive and release the adhesive from a bond surface of the component. At least a portion of the adhesive layer, such as a tab defined by the adhesive or otherwise coupled to the adhesive layer, may be coupled to the adhesive removal member, e.g., with the aid of an attachment mechanism (e.g., a clamp) or by adhering the portion of the adhesive layer to the adhesive removal member. The adhesive removal member may apply a pulling force to one portion of the adhesive layer in order to stretch the layer of adhesive, where the portion may be a side of the adhesive layer portion that defines a dimension between a first side and a second side. In some embodiments, the adhesive removal member applies a substantially uniform pulling force along the dimension (e.g., a length or width) between the first side and the second side of the adhesive layer. The adhesive removal member may be manually actuated by a user or by an automated device, such as a motor coupled to a control device. The automated device may be used alone or in combination with user interaction to actuate the adhesive removal member.

In some embodiments, the adhesive removal member comprises a rotatable portion that helps stretch the adhesive of the adhesive layer and release the adhesive layer from the component. For example, the adhesive removal member may comprise a mandrel or friction rollers that are coupled to a base at a fixed position or a mandrel that is movable relative to the base, e.g., along a gear track or movable relative to the first member that holds the component. After mechanically coupling at least a portion of the adhesive to the adhesive removal member, the rotatable portion of the adhesive removal member may be rotated, thereby applying a pulling force to the adhesive to stretch the adhesive and draw the adhesive away from the bond surface of the component. In some embodiments, the first member and rotatable portion of the adhesive removal member may be held in relatively fixed positions relative to each other or may be movable relative to each other.

In other embodiments, the adhesive removal member may comprise a second member that couples to at least a portion of the adhesive, and features that moves the first member and second member relative to each other. For example, the features may include a track on which the first member and/or second member are mounted, where the track enables the first and second members to move relative to each other, or enable the first and second members to move in substantially opposite directions. As another example, the second member may include a weight that is gravity fed away from the first member.

An adhesive removal system may include a cutting member in some embodiments in order to help remove the stretched and released adhesive from the rotatable portion, as well as features for collecting the adhesive that is removed from a component. The systems and methods described herein may be useful for removing an adhesive layer that is positioned between a glass substrate (or plate) and a liquid crystal display (LCD) without substantially damaging the glass substrate or the LCD. After removing the adhesive from the component, a user may determine whether the component has been damaged, e.g., as a result of the adhesive removal process.

In one embodiment, the present disclosure is directed to a system comprising a first member that holds a component comprising an adhesive layer, and an adhesive removal member that comprises a rotatable portion that moves the adhesive layer relative to the component.

In another embodiment, the present disclosure is directed to a system comprising a base, a first member that holds a component comprising an adhesive layer, and a second member that couples to at least a portion of the adhesive layer, wherein at least one of the first or second members are movably mounted to the base, the first and second members being movable relative to each other.

In another embodiment, the present disclosure is directed to a system comprising means for holding a component comprising an adhesive layer, and means for moving the adhesive layer and component relative to each other, wherein the means for moving couples to at least a portion of the adhesive layer.

In another embodiment, the present disclosure is directed to a system comprising introducing a component into a first member of an adhesive removal system, wherein the component comprises an adhesive layer, coupling at least a portion of the adhesive layer to an adhesive removal member, and actuating the adhesive removal member to stretch the adhesive.

In another embodiment, the present disclosure is directed to a system comprising securing a component to first member of an adhesive removal system, where the component comprises an adhesive layer, coupling at least a portion of the adhesive layer to a second member of the an adhesive removal member, and moving at least one of the first or second members along a track to stretch the adhesive.

In another embodiment, the present disclosure is directed to a computer-readable medium containing instructions. The instructions cause a programmable processor to actuate an adhesive removal member of an adhesive removal system. In one embodiment, the instructions cause a programmable processor to rotate an adhesive removal member at a speed sufficient to stretch an adhesive that is bonded to a component, and draw the adhesive away from a component.

In one aspect, the present disclosure provides for a device for removing a stretch release adhesive from at least one substrate, the device comprising: (a) a base having a top surface and opposing first and second edges; (b) a first side wall disposed on the top surface and along the first edge of the base; (c) a second side wall disposed on the top surface and along the second edge of the base; (d) a platform having means for attaching to the first and second side walls and having opposing, front and back edges; and (e) a support plate disposed proximate to the front edge of the platform. The combination of the base, the first side wall, the second side wall, and the platform forms a cavity comprising means for supplying a carrier tape to the support plate thereby allowing the stretch release tape to engage with the carrier tape.

The details of one or more embodiments of the present disclosure are set forth in the accompanying drawings and the description below. Other features, objects, and advantages of the present disclosure will be apparent from the description and drawings, and from the claims.

### BRIEF DESCRIPTION OF DRAWINGS

FIGS. 1 and 2 are schematic illustrations of an embodiment of an adhesive removal system.

FIG. 3 is a schematic partial cross-sectional view of a substrate and a platform of the adhesive removal system of FIG. 1.

FIGS. 4A-4C are schematic partial cross-sectional views of the adhesive removal system of FIG. 1, and illustrate an adhesive being pulled from a substrate.

FIG. 5 is a schematic side view of an embodiment of a mandrel that includes a structured outer surface.

FIG. 6 is a schematic perspective view of another embodiment of an adhesive removal system that includes a rotatable portion to draw an adhesive from a component, where the rotatable portion is easily removed from a base.

FIGS. 7A-7C are schematic illustrations of other examples of platforms that may be interchangeably coupled to a base of an adhesive removal system.

FIGS. 8A and 8B are schematic perspective views of another embodiment of an adhesive removal system, which includes a cutting member for removing adhesive from a mandrel.

FIGS. 9A and 9B are a schematic cross-sectional illustration of a cutting member of an adhesive removal system.

FIGS. 10A and 10B are schematic perspective views of another embodiment of an adhesive removal system, which includes a cutting system for removing adhesive from a mandrel.

FIGS. 11A-13B are schematic perspective views of another embodiment of an adhesive removal system, which includes a nip roller system to exert a pulling force on adhesive that is adhered to a component.

FIGS. 14A and 14B are schematic perspective views another embodiment of an adhesive removal system, which includes rollers for arranging removed adhesive into an organized aggregation of adhesive.

FIGS. 15A and 15B are schematic perspective views another embodiment of an adhesive removal system, which includes gears and a gear train and/or rack and pinion for driving the rotation of a mandrel that applies a pulling force to an adhesive layer of a component.

FIGS. 16A and 16B are schematic perspective views another embodiment of an adhesive removal system, which stretches an adhesive layer of a component by sliding a beam along a channel.

FIGS. 17A and 17B are schematic perspective views another embodiment of an adhesive removal system, which utilizes vacuum force to hold a component.

FIGS. 18A-18C are schematic illustrations of another embodiment of an adhesive removal system, which includes cam rollers to hold a component.

FIGS. 19A-19B are schematic perspective views another embodiment of an adhesive removal system, which includes clamping members to hold a component.

FIGS. 20A-20B are schematic perspective views another embodiment of an adhesive removal system, which includes a nip roller system to exert a pulling force on adhesive that is bonded to a component and a collection bin that receives adhesive removed from the component.

FIG. 21 is a schematic side view of another embodiment of an adhesive removal system, which includes a weight to exert a pulling force on adhesive that is bonded to a component.

FIG. 22 is a schematic side view of a system that may be used in any adhesive removal systems including a collection roller in order to help maintain a particular orientation between the portion of adhesive layer being removed from component and an adhesive removal member.

FIG. 23 is a perspective view of another exemplary adhesive removal device in accordance with this disclosure.

FIG. 24 an exploded view of the embodiment of FIG. 23.

FIG. 25 is a partial cut away side view of the embodiment of FIG. 23.

FIG. 26 is a schematic, cross-sectional view of an exemplary stretch release adhesive adhered to a plurality of substrates.

These figures are idealized, are not drawn to scale, and are intended only for illustrative purposes.

### DETAILED DESCRIPTION

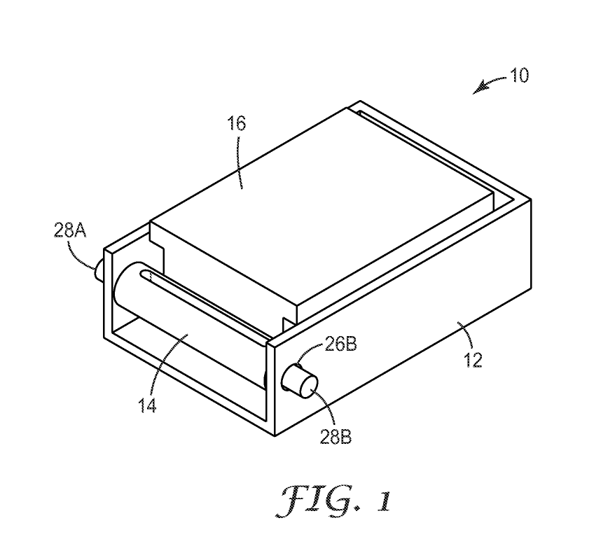

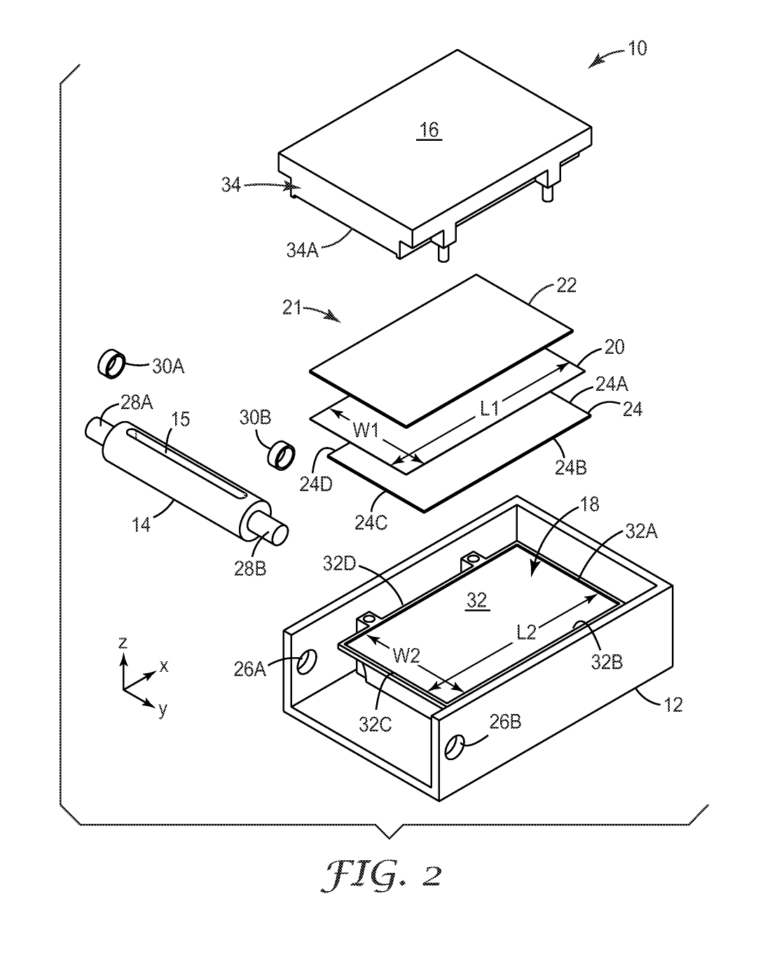

FIG. 1 is a schematic perspective view of an adhesive removal system 10, and FIG. 2 is a schematic exploded view of the adhesive removal system 10. Adhesive removal system 10 includes base 12, mandrel 14, cover member 16, and platform 18. Adhesive removal system 10 is useful for removing an adhesive layer 20 from a component 21, where adhesive of adhesive layer 20 comprises stretch release properties. Adhesive comprising stretch release properties may be adhered to at least a portion of component 21 and then removed by stretching the adhesive in a direction substantially along the bond surface of component 21 or up to an angle of about 35 degrees (°) relative to a major surface of the bond surface of component 21. Some stretch release adhesives may be removed from component 21 (or “substrate 21”) without leaving traces of residue on component 21 and without imparting any perceptible damage to the bond surface of component 21. An example of a stretch release adhesive is described in U.S. Pat. No. 5,989,708 (Kreckel), hereby incorporated by reference.

In the embodiment shown in FIG. 2, component 21 includes two bond surfaces defined by glass plate 22 and a liquid crystal display (LCD) module 24, which may include a respective glass plate, an LCD element (e.g., including liquid crystals), and a touch panel display. Alternatively, the bond surfaces may be defined by two glass plates or glass plate 22 and a touch panel display. Adhesive 20 may be, for example, an optically clear adhesive exhibiting stretch release properties, such as the adhesive described in commonly-assigned U.S. Provisional Patent Application No. 61/020,423, entitled, “STRETCH RELEASING OPTICALLY CLEAR PRESSURE SENSITIVE ADHESIVE”, filed on Jan. 11, 2008; U.S. Provisional Patent Application No. 61/036,501 entitled “OPTICALLY CLEAR STRETCH, RELEASABLE ADHESIVE TAPE”, filed on Mar. 14, 2008; and U.S. Provisional Patent Application No. 61/141,767, entitled, “STRETCH RELEASABLE ADHESIVE TAPE”, filed on Dec. 31, 2008.

In some examples, glass plate 22 and LCD module 24 are separated by a about 175 micrometers, i.e., adhesive layer 20 is about 175 micrometers thick. Component 21 may be, for example, a display of a mobile handheld device (e.g., a mobile telephone, a personal digital assistant, a portable music player, and the like), a display of a computing device (e.g., a laptop computer or a desktop computer) or another display, such as a display of a television. In other embodiments, adhesive removal device 10 may be used to remove an adhesive layer 20 from another component. In general, adhesive removal system 10 may be configured to accommodate substrates having various sizes and configurations. Accordingly, while adhesive removal system 10 is primarily described with respect to component 21 including glass plate 22 and LCD module 24, the invention is not so limiting.

In some cases, it may be desirable to remove adhesive layer 20 from component 21 in order to rework the arrangement between glass plate 22 and LCD module 24, in order to replace at least one of glass plate 22 or LCD module 24 or to remove contaminants (e.g., dust) that may be trapped between adhesive layer 20 and glass plate 22 or between adhesive layer 20 and LCD module 24. Other reasons for removing adhesive layer 20 from component 21 are also possible. It may be desirable to remove adhesive layer 20 to separate the parts of component 21 rather than disposing of the entire component 21 for part-conservation reasons, as well as for waste minimization. If glass plate 22 and LCD module 24 are separated from each other, as well as adhesive layer 20, without substantial damage, glass plate 22 and/or LCD module 24 may be recycled, e.g., reused in another component. Stretch release adhesive 20 enables glass plate 22 and LCD module 24 to be separated from each other without substantially damage to glass plate 22 or LCD module 24. Adhesive removal system 10 helps remove adhesive layer 20 from component 21.

After removing the adhesive from the component, a user may determine whether the component has been damaged, e.g., as a result of the adhesive removal process. For example, in the case of LCD module 24 (or LCD panel), the user may plug LCD module 24 into a handheld device (e.g., a mobile phone)or another device that includes a similar LCD display. The backlight of the handheld device may be activated and damaged pixels of the LCD module may become visible to the user. In this way, the user may visually inspect component 21 for damage after adhesive layer 20 is removed therefrom.

In order to remove stretch release adhesive layer 20 from component 21, it may be desirable to exert a pulling force to stretch adhesive layer 20 that is substantially evenly distributed along the entire side from which adhesive layer 20 is pulled. For example, if adhesive layer 20 is pulled along width W1, it may be desirable to exert a substantially even pulling force along the entire width W1, rather than concentrating the force at one portion of width W1. Similarly, if adhesive layer 20 is pulled along length L1, it may be desirable to exert a substantially even pulling force along the entire length L1, rather than concentrating the force at one portion of length L1. Pulling at one portion of width W1 or length L1 may cause adhesive layer 20 to rip, tear or otherwise break. Adhesive removal system 10 may help exert a substantially even pulling force along the pull-side of adhesive layer 20. In addition, as described in further detail below, adhesive removal system 10 may help pull adhesive layer 20 from component 21 within a particular range of angles.

Base 12 of adhesive removal system 10 supports component 21 relative to the adhesive removal portion of system 10, and, in particular, mandrel 14. Base 12 defines openings 26A, 26B configured to receive arms 28A, 28B, respectively, of mandrel 14. At least one of the arms 28A, 28B may be spring-loaded, and the spring-loaded arm may be depressed toward the opposing arm in order to size mandrel 14 for fitting into base 12 and allow arms 28A, 28B to be introduced through openings 26A, 26B. In the embodiment shown in FIGS. 1 and 2, arms 28A, 28B are rotatably mounted within openings 26A, 26B of base 12 with the aid of bearings 30A, 30B. Bearings 30A, 30B may be positioned between arms 28A, 28B, respectively, and openings 26A, 26B of base 12. In this way, bearings 30A, 30B provide an interface between mandrel 14 and openings 26A, 26B. Bearings 30A, 30B may be any suitable bearing configured to permit rotational movement between mandrel 14 and base 12. For example, bearings 30A, 30B may be ball bearings, sliding bearings, fluid bearings, and the like. An aperture defined by bearings 30A, 30B may be configured to engage with the outer surfaces of arms 28A, 28B, such that bearings 30A, 30B are interference fit with arms 28A, 28B, respectively. Other mechanisms for mechanically coupling bearings 30A, 30B and arms 28A, 28B, respectively are contemplated, such as the use of an adhesive or welding (e.g., ultrasonic welding). In addition, in some embodiments, arms 28A, 28B may be directly couples to base 12 without the aid of bearings 30A, 30B.

Platform 18 is secured within base 12 with the use of any suitable coupling technique, such as, but not limited to, interlocking parts (e.g., a snap fit), an adhesive, welding (e.g., ultrasonic welding), screws, nails or the like. In particular, platform 18 and mandrel 14 are coupled to base 12 such that mandrel 14 and platform 18 are held at a relatively constant distance relative to each other. In some embodiments, platform 18 may be removably mounted to base 12, which may enable different platforms to be interchangeably coupled to base 12. The different platforms may help customize adhesive removal system 10 to different sized components. In addition, a removable platform 18 may be useful for adhesive removal system 10, which may inadvertently acquire a build-up of adhesive or other contaminants over time.

Platform 18 defines a compartment 32 sized and configured to engage with LCD module 24 of component 21. In other embodiments, compartment 32 may be sized and configured to receive glass plate 22 of component 21 instead of or in addition to LCD module 24. Walls 32A-32D of compartment 32 are sized based on walls 24A-24D, respectively, of LCD module 24. In one embodiment, walls 32A-32D are sized to engage with walls 24A-24D of LCD module 24 when component 21 is introduced into compartment 32. However, in some cases, a friction fit between walls 24A-24D and walls 32A-32D may be undesirable because ease of removal of LCD module 24 after adhesive layer 20 is removed from component 21 may be desirable. A depth of compartment 32 (measured substantially along the z-axis direction, where orthogonal x-y-z axes are shown in FIG. 2) may be less than or equal to a depth of LCD module 24 (also measured substantially along the z-axis direction), such that when component 21 is introduced into compartment, adhesive layer 20 protrudes from compartment 32, as schematically shown in FIG. 3.

FIG. 3 is a schematic cross-sectional illustration of component 21, which is received in compartment 32 of platform 18. As shown in FIG. 3, depth D1 of walls 32A-32D of compartment 32 is less than or equal to depth D2 of LCD module 24. In this way, when component 21 is introduced into compartment 32, adhesive layer 20 and glass plate 22 sit at or above a top surface 18A of platform 18. As described below, this arrangement between component 21 and platform 18 enables adhesive 20 to be separated from glass plate 22 and LCD module 24.

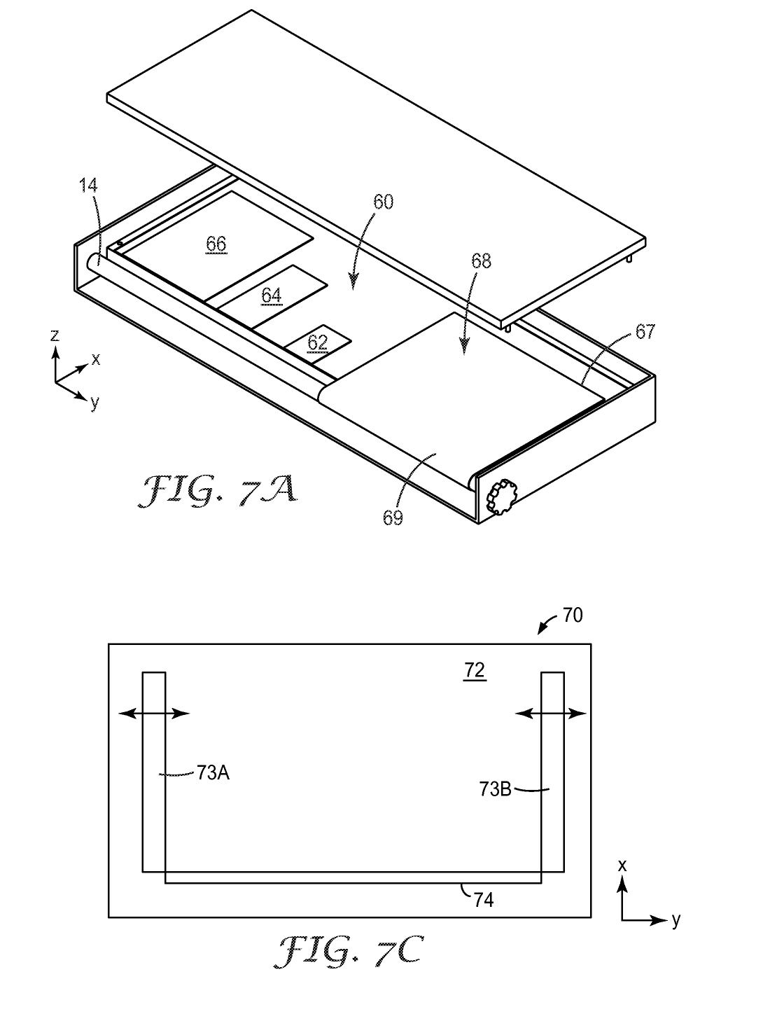

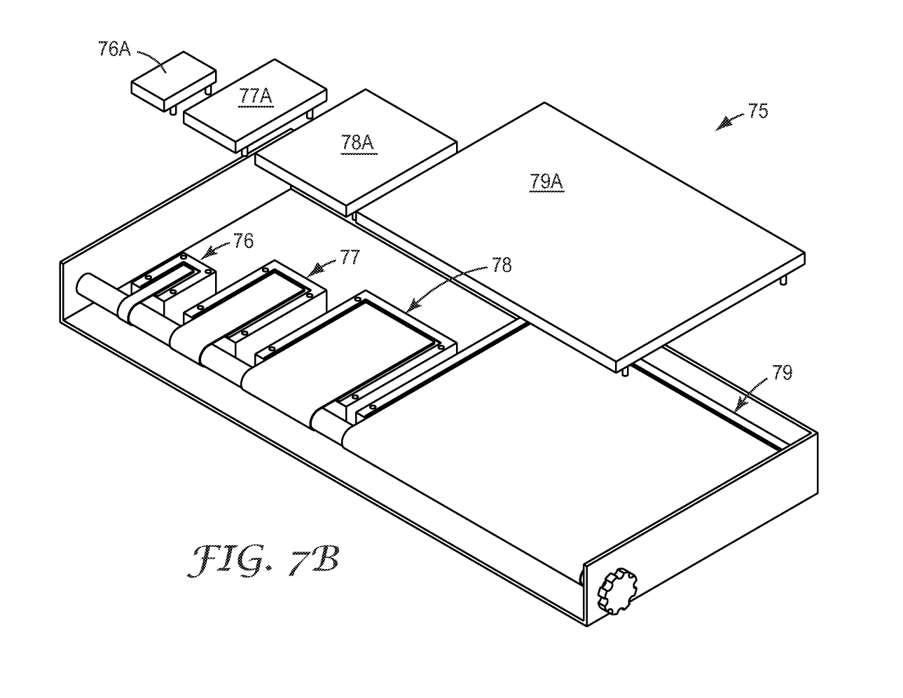

Although FIGS. 2-3 illustrate a platform 18 defining compartment 32 that has dimensions (length L2 and width W2, as shown in FIG. 2) that substantially match the dimensions of LCD module 24, in other embodiments, compartment 32 may have other suitable dimensions. For example, platform 18 may have a greater length L2 and/or width W2 than LCD module 24, and may include movable members that engage with a portion of component 21 once the portion of component 21 is introduced into compartment 32. In this way, compartment 32 may accommodate different sized components 21. As another example, platform 18 may have a greater length L2 and/or width W2 than LCD module 24 and LCD module 24 may sit within the larger space defined by compartment 32 with or without any further mechanisms to secure LCD module 24 within compartment 32. Other embodiments of platforms are described with respect to FIGS. 7A-7C.

In some cases, cover member 16 may be used to help secure component 21 within compartment 32 defined by platform 18. In the embodiment shown in FIGS. 1-2, cover member 16 defines lip 34 that may engage with glass plate 22 of component 21 when cover 16 is coupled to base 12. Slot 36, which is define by lip 34 and platform 18 when cover member 16 is attached to base 12, may be sized to receive adhesive layer 20. Adhesive layer 20 may be pulled from component 21 through slot 36 defined by lip 34 of cover 16, and, as adhesive layer 20 is pulled from component 21, glass plate 22 may engage with an interior surface of lip 34 (not shown in FIG. 2) and LCD module 24 may engage with wall 32C of compartment 32. In this way, glass plate 22 and LCD module 24 may resist any pulling forces that result from pulling adhesive 20 from component 21 and the position of glass plate 22 and LCD module 24 may remain substantially fixed.

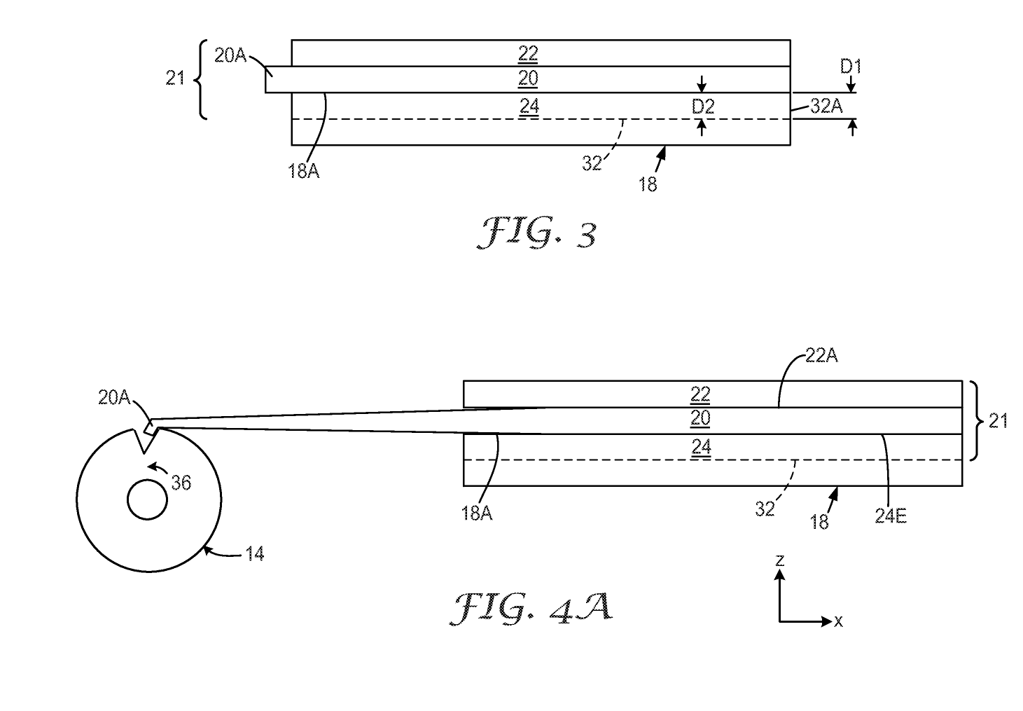

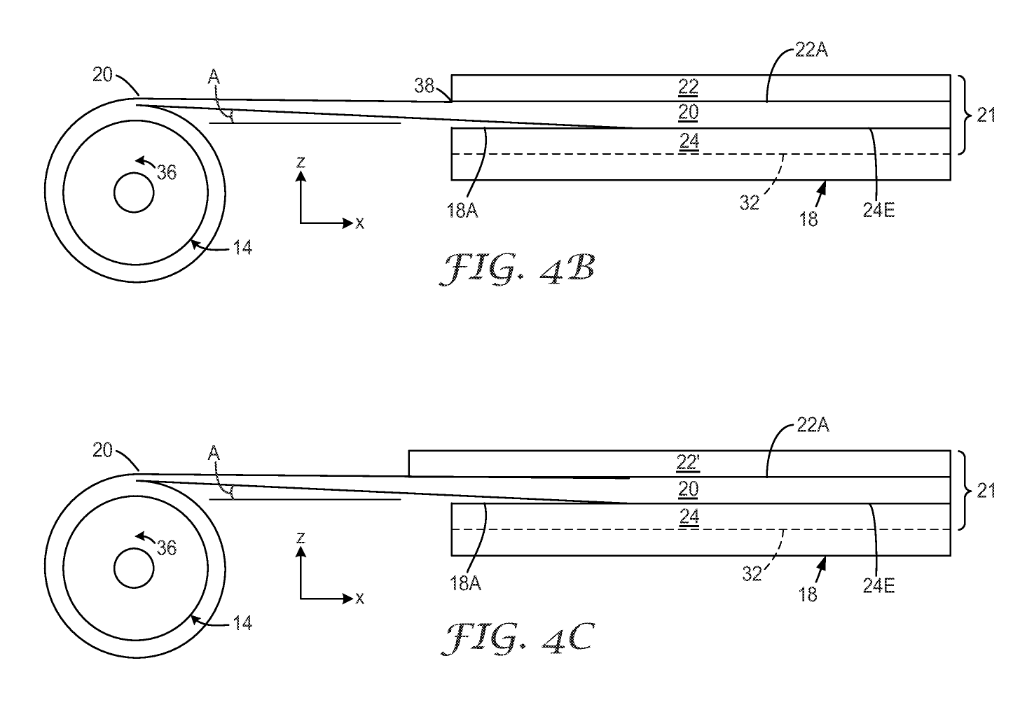

Adhesive layer 20 may be pulled from component 21 with the aid of rotatably mounted mandrel 14. Adhesive layer 20 defines tab 20A (shown in FIG. 3), which may be a portion of adhesive layer 20 that is not bonded to component 21, or may be defined by another element that is directly or indirectly attached to adhesive layer 20. Adhesive layer 20 may be coupled to mandrel 14 by any suitable technique. In one embodiment, tab 20A is adhered to mandrel 14, as shown in FIG. 4A, which is a schematic cross-sectional view of component 21, platform 18, and mandrel 14. In the embodiment shown in FIG. 4A, tab 20A of adhesive layer 20 is introduced into groove 15 defined by mandrel 14, and adheres to a surface of groove 15. Alternatively, tab 20A may be bonded to a different surface of mandrel 14, such as an outer surface. Base 12 is not shown in the schematic cross-sectional views of FIGS. 3-4C for clarity of illustration.

Prior to bonding tab 20A to mandrel 14 or another adhesive removal member, tab 20A may be at least partially covered with a release liner in order to help prevent tab 20A from inadvertently bonding to another surface prior to the adhesive removal process. The release liner may be, for example, a polymer film or another material that may easily be removed from adhesive layer 20. In some embodiments, the release liner or tape may remain on tab 20A during the adhesive removal process. For example, a clamp may attach tab 20A of adhesive 20 to mandrel 14, and the release liner or tape may help tab 20A from adhering to the mandrel 14. As another example, if adhesive 20 is pulled from component 21 with the aid of nip rollers, as described with respect to FIGS. 11A and 11B, the release liner may remain on tab 20A in order to allow tab 20A to be led through the nip rollers without adhering thereto.

In other embodiments, tab 20A, which may or may not be covered with a release liner, may be coupled to mandrel 14 using any suitable technique. For example, in some embodiments, mandrel 14 may include a mechanism that clamps or otherwise engages with and holds tab 20A. Thus, while a technique including bonding tab 20A to mandrel 14 is primarily referred to in the description of FIG. 4, in other embodiments, other techniques for coupling adhesive layer 20 to mandrel 14 are contemplated.

As shown in FIG. 4A, in order to bond tab 20A to mandrel 14, adhesive layer 20 is stretched substantially along the major planes of the surfaces of component 21 to which adhesive layer 20 is bonded. In the embodiment shown in FIG. 4, the major planes of the surfaces of component 21 to which adhesive layer 20 is bonded include major surface 22A of glass plate 22 and major surface 24E of LCD module 24. Because adhesive layer 20 has stretch release properties, adhesive layer 20 may be stretched relatively extensively in the bond plane (the x-axis direction in FIG. 4A) without breaking. In order to remove stretch release adhesive layer 20 from component 21, adhesive layer 20 is stretched, e.g., by pulling adhesive layer 20 in a direction away from component 21. With some stretch release adhesives, adhesive layer 20 may be stretched in a direction substantially parallel to bond surfaces 22A, 24E of component 21 in order to remove adhesive layer 20 from component 21 such that there is no visible residue remaining on component 21 and no visible damage to the component 21. In addition, some stretch release adhesives permit adhesive layer 20 to be stretched in a direction in a range of about 0° (i.e., substantially parallel) to about 35° relative to bond surfaces 22A, 24E. However, different stretch release adhesives may be removed from component 21 with other desirable angles of stretch.

In the embodiment of adhesive removal system 10 shown in FIGS. 1-4, adhesive layer 20 may be pulled in a direction away from component 21 by rotating mandrel 14 in a direction 36 (shown in FIG. 4A) away from component 21 (e.g., the counterclockwise direction). In some embodiments, mandrel 14 may be manually rotated by a user, e.g., by directly or indirectly grasping and rotating one or both arms 28A, 28B of mandrel 14. Arms 28A, 28B may be indirectly grasped and rotated, e.g., by coupling a knob to arms 28A, 28B or by coupling another type of member that provides a grip surface for arms 28A, 28B. In other embodiments, mandrel 14 may be rotated with the aid of an automated device, such as a gear motor that is coupled to a controller that controls the gear motor.

As mandrel 14 is rotated in the counterclockwise direction 36, adhesive layer 20 is pulled from component 21 and wraps around mandrel 14. In some embodiments, adhesive removal system 10 includes a rotation-limiting member that discourages mandrel 14 from rotating in a direction toward component 21 (i.e., in a clockwise direction in FIG. 2). For example, bearings 30A, 30B (FIG. 2) may each by coupled to a ratcheting mechanism, worm gear or suitable feature that limits the movement of mandrel 14 in the clockwise direction. Limiting rotation of mandrel 14 in the clockwise direction may help prevent portions of adhesive layer 20 that have been pulled from component 21 from being pulled back to component 21 and rebonding to component 21. Adhesive that has been stretched may be relatively difficult to remove from component 21. Adhesive 20 may have a maximum amount of stretch prior to tearing, ripping or otherwise breaking. Thus, if stretched adhesive 20 is rebonded to component 21, it may be difficult to re-stretch the adhesive 20 in order to remove the rebonded stretched adhesive from component 21.

In some cases, such as if rotation of mandrel 14 in a direction substantially opposite to direction 36 is limited with a ratcheting mechanism, some rotation of mandrel 14 toward component 21 may be permitted. For example, system 10 includes one or more ratchets with a gearwheel or another member forming teeth, the teeth may only prevent movement in a direction substantially opposite to direction 36 at discrete points (e.g., when a pawl or another finger is positioned between the teeth of the gearwheel).

In embodiments in which an electromechanical device or another automated device is used to rotate mandrel 14, the device may include a self-regulating motor or another system that helps prevent turning mandrel 14 at a speed that stresses adhesive 20. It may be undesirable to pull adhesive layer 20 from component 21 too fast in order to help prevent overstressing adhesive layer 20. If adhesive layer 20 is overstressed, adhesive layer 20 may break or tear. Examples of self-regulating motors include motors utilizing planetary gears. In some embodiments, the speed at which a device automatically rotates mandrel 14 (e.g., the revolutions per minute of mandrel 14) may be regulated by a controller, which may be programmed to control rotation of mandrel 14 at or below a particular speed threshold. The desirable speed at which the device may rotate mandrel 14 may be selected based on the properties of the adhesive 20, as well as other factors, such as the dimensions of mandrel 14 and the distance between mandrel 14 and component 21.

As previously indicated, with some stretch release adhesives, adhesive layer 20 is pulled from component 21 at a particular angle, e.g., less than about 35° relative to bond surfaces 22A, 24E of component 21 in order to effectively use the stretch release properties of adhesive layer 20 to remove adhesive layer 20 from component 21. As adhesive layer 20 wraps around mandrel 14, the angle A (shown in FIG. 4B) at which adhesive layer 20 is pulled from component 21 increases. In some cases, angle A may exceed the desirable angle for stretching adhesive layer 20 in order to maximize the stretch release properties of adhesive layer 20 and minimize stress applied to adhesive layer 20. In addition, in some cases, as angle A increases, the possibility of adhesive layer contacting edge 38 (shown in FIG. 4B) of glass plate 22 increases. Contact between adhesive layer 20 and edge 38 may be undesirable because edge 38 may apply pressure to adhesive layer 20 as adhesive layer 20 is pulled against edge 38, and may puncture or otherwise cause adhesive layer 20 to tear, rip, break or the like.

Adhesive 20 may re-adhere to glass plate 22 as it is pulled from component 21 if the angle A between the bond surfaces of component 21 and the surface of mandrel 14 or the outer surface of removed adhesive collected on mandrel 14 is such that portions of adhesive layer 20 contact bond surfaces 22A of glass plate 22. The possibility that portions of adhesive 20 that have been pulled from component 21 will re-adhere to glass plate 22 may be increased if glass plate 22 has a greater dimension along the x-axis direction than LCD module 24, as shown with glass plate 22′ in FIG. 4C.

In order to help minimize or even eliminate the consequences of increasing angle A beyond a desirable range of angles (e.g., about 35° or less), adhesive removal device 10 may include features that enable angle A between adhesive layer 20 and mandrel 14 to remain at or below the threshold angle. In some embodiments, mandrel 14 may be movable relative to base 12, such that mandrel 14 may move in the negative z-axis direction as the thickness of adhesive layer 20 on mandrel 14 increases. In this way, the angle A between adhesive layer 20 and the bond surfaces 22A, 24E of component 21 may be maintained at or below a threshold angle.

A user may manually move mandrel 14 or mandrel 14 may be moved automatically as sensors within base 12 or on mandrel 14 detect a thickness of adhesive layer 20 on mandrel 14 and/or the angle A between the portion of adhesive layer 20 being stretched onto mandrel 14 and the bond surfaces 22A, 24E of component 21. For example, base 12 may define a plurality of sets of openings 26A, 26B that each have a different z-axis position. The plurality sets of openings 26A, 26B may be connected, such that arms 28A, 28B of mandrel 14 may be slid or otherwise moved between adjacent openings 26A, 26B without removing mandrel 14 from base 12. As another example, mandrel 14 may be rotatably mounted to base 12 by a lever mechanism that enables the z-axis position of mandrel 14 to be adjusted. Other arrangements for adjusting the z-axis position of mandrel 14 are contemplated. For example, the z-axis position of component 21 may be adjusted as the thickness of adhesive collected on mandrel 14 increases.

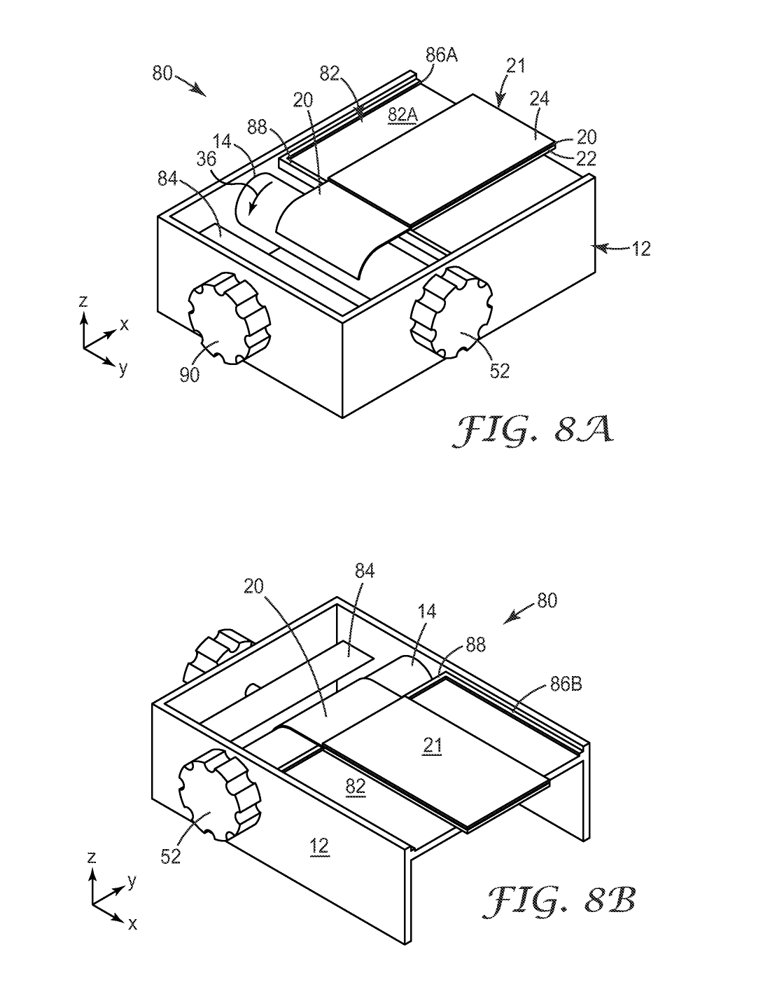

In addition to or instead of moving mandrel 14 in order to maintain the angle A between bond surfaces 22A, 24E of component 21 and the portion of adhesive layer 20 being removed from component 21 within a desirable range, the portions of adhesive layer 20 wrapped around mandrel 14 may be removed as adhesive layer 20 is pulled from component 21. An example of a system that includes a cutting device to remove adhesive layer 20 from mandrel 14 is described below with reference to FIGS. 8A-10B.

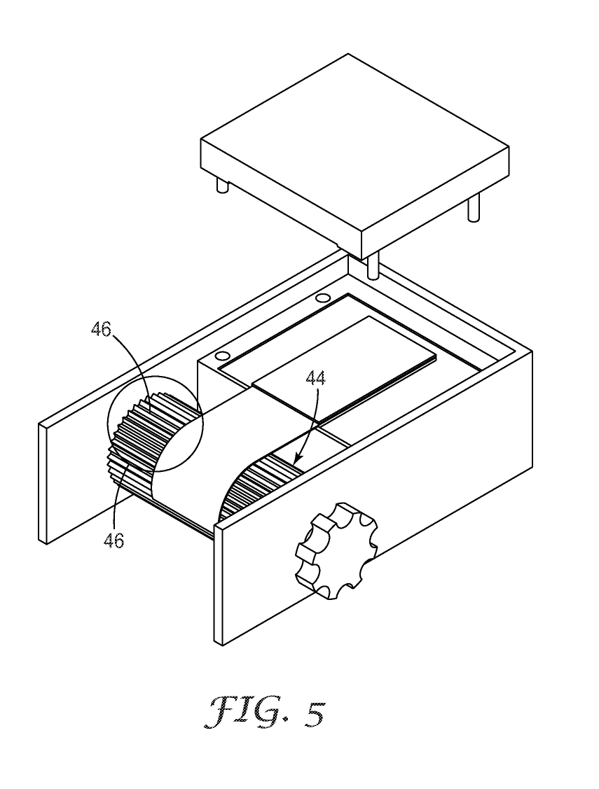

Mandrel 14 may define a structured (e.g., a microstructured) surface on which the adhesive 20 removed from component 21 may collect. FIG. 5 is a schematic perspective view of an embodiment of a mandrel 44 that includes a structured outer surface 46. Adhesive layer 20 may be wrapped around outer surface 46 as adhesive layer 20 is pulled from component 21. Structured (also referred to as “replicated”) outer surface 46 help minimize the surface area of mandrel 44 that adheres to any removed adhesive 20. Minimizing the surface area of mandrel 44 that bonds to any removed adhesive 20 may help minimize the bond strength between the removed adhesive 20 and the mandrel 44. Accordingly, structured outer surface 46 may help decrease the force and, in some cases, the effort required to detach adhesive 20 from mandrel 44. The microstructures defined by outer surface 46 may be formed by any suitable technique, such as by molding or embossing mandrel 44 or at least a portion of mandrel 44.

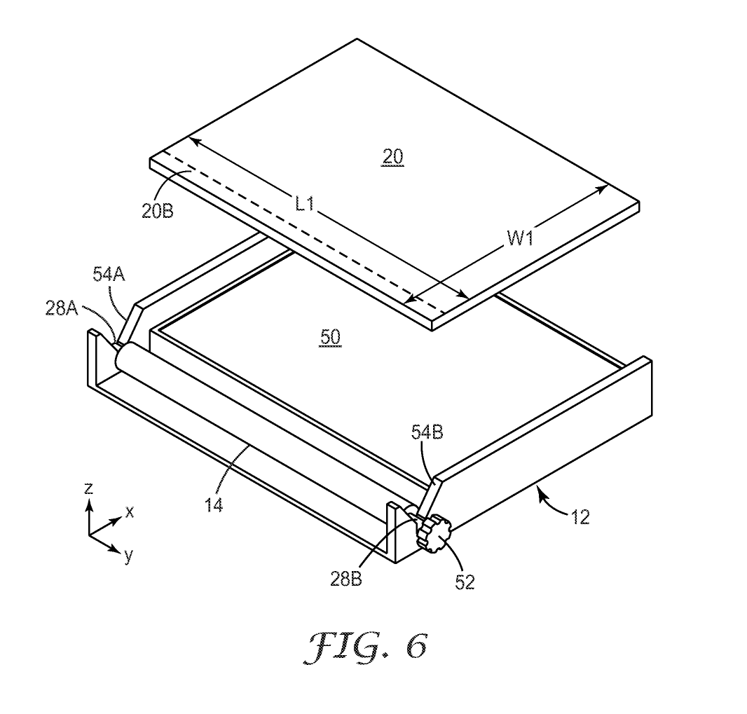

While the embodiment of adhesive removal system 10 shown in FIGS. 1-4C illustrate a system 10 that exerts a pulling force on a minor edge of adhesive layer 20 (i.e., along width W1, rather than length L1, in embodiments in which length L1 is greater than width W1), in other embodiments, system 10 may exert a pulling force along a major edge of adhesive layer 20. FIG. 6 is a schematic perspective view of adhesive removal system 10 that includes a platform 50 that is configured to receive component 21 such that a pulling force is exerted along the length L1 of adhesive layer 20. As previously indicated, base 12 of adhesive removal system 10 may be configured to receive different platforms that are sized to receive different substrates, and, as shown in FIG. 6, may be sized to orient the same substrate in different directions relative to mandrel 14. Platforms 18 (FIG. 2) and 50 are examples of different platforms that may be interchangeably coupled to base 12.

Adhesive layer 20 may define a tab 20B, which is similar to tab 20A, along the length LI instead of or in addition to tab 20A that extends along the width W1 of adhesive layer 20. Tab 20B along the length L1 of adhesive layer 20 may be bonded to mandrel 14 or otherwise attached to mandrel 14, and adhesive layer 20 may be removed from component 21 using the techniques described above with respect to FIGS. 1-4C.

In the embodiment shown in FIG. 6, rather than defining openings 26A, 26B (FIGS. 1-2), base 12 defines notches 54A, 54B configured to receiving arms 28A, 28B of mandrel 14. Notches 54A, 54B permit mandrel 14 to be dropped into base 12 without the need to modify the size of mandrel 14 by depressing one of the arms 28A, 28B. Also shown in FIG. 6 is knob 52, which is coupled to arm 28B of mandrel 14. Knob 52 provides a gripping surface that a user or automated device may grasp in order to rotate mandrel 14. Knob 52 may also help prevent mandrel from shifting along the y-axis direction.

FIGS. 7A-7C are schematic illustrations example of platforms that may be interchangeably coupled to base 12 in place of platform 18 shown in FIG. 2. FIG. 7A illustrates a schematic perspective view of platform 60, which is configured to receive substrates having different sizes. In particular, platform 60 defines compartments 62, 64, 66, and 67, which are configured to receive different-sized substrates. For example, compartment 62 may be configured to receive at least a portion of an LCD display from a mobile phone, compartment 64 may be configured to receive at least a portion of an LCD display from a portable digital music player, compartment 66 may be configured to receive at least a portion of an LCD display from a personal digital assistant, and compartment 67 may be configured to receive at least a portion of an LCD display from a laptop computer. The depth of each compartments 62, 64, 66, 67 (measured substantially along the z-axis direction) may differ or may be the same. Although compartments 62, 64, 66, 67 are shown to have rectangular shapes in FIG. 7A, in other embodiments, compartments 62, 64, 66, 67 may be shaped to receive substrates having other configurations.

Platform 60 may be coupled to base 12 and components may be introduced into any of the compartments 62, 64, 66, 67. The user may select the compartment 62, 64, 66, 67 that best accommodates the component. For example, in FIG. 7A, a portion of a display 68 of a laptop computer is introduced into compartment 67, such that a glass panel of the display is disposed within compartment 67 and an adhesive layer 69 bonded to the glass panel protrudes from the compartment 67.

Adhesive removal device 10 removes a stretch release adhesive 69 from display 68 by applying a tension force that is substantially evenly distributed along an edge of the adhesive 69. The substantially even force may be exerted along the edge of the adhesive, regardless of whether the edge of the adhesive is centered relative to mandrel 14. For example, FIG. 7A illustrates adhesive layer 69 of the display 68 in a stretched state, where adhesive layer 69 has been partially pulled from display 68 by mandrel 14, which applies a substantially uniform pulling force along the width of adhesive layer 69 (measured substantially along the y-axis direction). Thus, it is believed that adhesive removal device 10 may remove adhesive from a substrate positioned in compartment 62 or compartment 66 despite the fact that the compartment 62 may not be centered with mandrel 14 or another device that applies pulls the adhesive from the substrate. Mandrel 14 may substantially simultaneously apply a pulling force to adhesive layers of multiple components.

In other embodiments, a plurality of platforms may be attached to base 12, where at least two of the platforms define a different sized compartment. FIG. 7B illustrates an adhesive removal system 75 that includes a plurality of platforms 76, 77, 78, 79. As shown in FIG. 7B, platforms 76, 77, 78, 79 may simultaneously receive respective substrates that includes an adhesive. In addition, each platform 76, 77, 78, 79 may have a cover member 76A, 77A, 78A, 79A, respectively. Alternatively, two or more of the platforms 76, 77, 78, 79 may have a common cover.

Neither compartment 32 of platform 18 (FIG. 2) nor compartments 62, 64, 66, 67 of platform 60, nor the compartments of platforms 76, 77, 78, 79 need to define walls that surround a portion of a substrate. Instead, the platform compartments may define a front stop along the side of the compartment 32, 62, 64, 66 that is closest to mandrel 14. An example of such a platform is shown in FIG. 7C, which is a schematic top view of platform 70.

Platform 70 defines a substantially planar top surface 72 and a front wall 74 protruding from the top surface 72 in the z-axis direction (substantially perpendicular to the plane of the image of FIG. 7C). Either glass plate 22 or LCD module 24 of component 21 may be positioned on top surface 72 and engaged with wall 74. The depth of wall 74 (measured in the z-axis direction) may be adjustable in some embodiments. Wall 74 engages with component 21 to restrain either glass plate 22 or LCD module 24 as adhesive 20 is pulled from between glass plate 22 and LCD module 24. In some cases, the unrestrained portion of component 21 may at least partially move with adhesive 20, particularly as the adhesive is pulled from the portion of component 21 furthest from wall 74.

Platform 70 also includes movable sidewalls 73A, 73B, which are movable along the y-axis direction. For example, side walls 73A, 73B may be movably mounted to tracks that extend along the y-axis direction. Sidewalls 73A, 73B may be locked in place. The y-axis position of sidewalls 73A, 73B be adjusted based on the configuration of component 21. For example, sidewalls 73A, 73B may be moved to engage with side surfaces of component 21 in order to help more securely hold component 21 on platform 18. Adjustable sidewalls 73A, 73B (and adjustable front wall 74) may enable platform 70 to be customizable for use with various types and sizes of substrates. In other embodiments, platform 70 may also include an adjustable or nonadjustable rear wall that is parallel to front wall 74.

FIGS. 8A and 8B are schematic perspective views of an embodiment of adhesive removal system 80, which includes base 12, mandrel 14 coupled to knob 52, platform 82, and cutting member 84. Platform 82 is similar to platform 70 of FIG. 7C, but does not include movable sidewalls. As shown in FIGS. 8A and 8B, platform 82 defines a top surface 82A, sidewalls 86A, 86B that protrude from top surface 82A, and front wall 88 that protrudes from top surface 82A. Component 21 is positioned on top surface 82A, such that glass plate 22 is engaged with front wall 88, while adhesive layer 20 and LCD module 24 are unconstrained.

After adhesive layer 20 is coupled to mandrel 14 (e.g., by directly bonding adhesive layer 20 to an outer surface of mandrel 14, as shown in FIGS. 8A and 8B), mandrel 14 may be rotated in direction 36 in order to stretch adhesive 20 and remove adhesive 20 from between glass plate 22 and LCD module 24. As the tensile forces are applied to adhesive 20 from the rotation of mandrel 14, glass plate 22 abuts front wall 88 of platform 82. In this way, front wall 88 restrains component 21 as adhesive 20 is removed from component 21. As previously indicated, a user may rotate mandrel with the aid of knob 52 or mandrel 14 may be automatically rotated with the aid of an automated device that is, e.g., coupled to a computing device that controls mandrel 14.

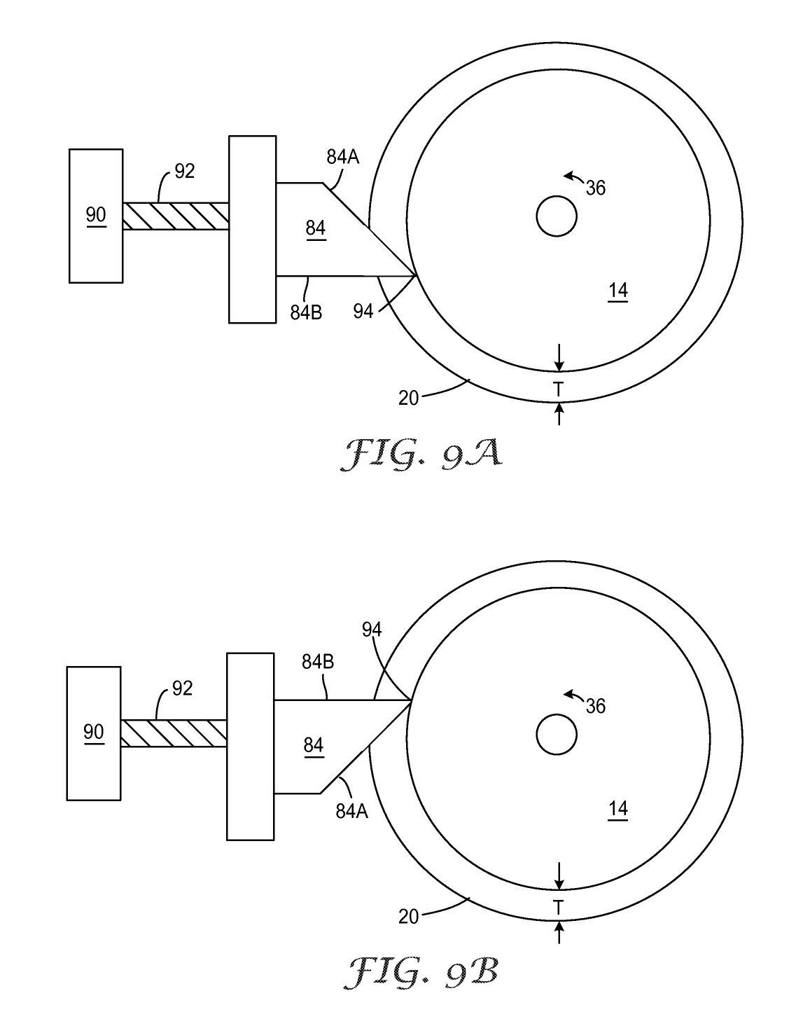

Cutting member 84 may help remove adhesive 20 from mandrel 14. A width of cutting member 84, which is measured substantially along the y-axis direction) substantially matches a width of mandrel 14. For example, a width of cutting member 84 may be about 80% to about 100% the length of mandrel 14. However, cutting member 84 may have any suitable width. In the embodiment shown in FIGS. 8A-8B, cutting member 84 is movable toward mandrel 14 along the x-axis direction. For example, cutting member 84 may be mounted to base 12 with a threaded member (shown in FIG. 9A) that is coupled to knob 90. As knob 90 is rotated in one direction (e.g., the counterclockwise direction), cutting member 84 may advance toward mandrel 14. As knob 90 is rotated in the opposite direction, cutting member may retreat away from mandrel 14. Cutting member 84 may be movably mounted to base 12 such that cutting member 84 does not penetrate an outer surface mandrel 84, but, may instead contact the outer surface of mandrel 14. In some embodiments, cutting member 84 may be mounted to base such that cutting member 84 does not contact mandrel 84. However, in some embodiments, cutting member 84 may be mounted to base 12 such that cutting member 84 contacts an outer surface of mandrel 14 or extends into groove 15 in mandrel 14.

If adhesive 20 is wrapped around mandrel 14 or otherwise attached to mandrel 14, a user may position cutting member 84 proximate to mandrel 14. Cutting member 84 may be positioned to penetrate all or some of the adhesive 20 on mandrel 14 in order to help detach at least a portion of the adhesive 20 from mandrel 14. Because cutting member 84 has a width that substantially matches a width of mandrel 14, the y-axis position of cutting member 84 does not need to be adjusted in order to remove a large portion of adhesive 20 from mandrel 14. In some embodiments, a user or automatic device may align groove 15 with cutting member 84 and advance cutting member 84 toward mandrel 14 such that cutting member 84 extends into groove 15. This arrangement between cutting member 84 and groove 15 allows cutting member 84 to penetrate through substantially the entire thickness of adhesive 20 collected on the outer surface of mandrel 14.

FIG. 9A is a schematic cross-sectional illustration of cutting member 84 piercing through a layer of adhesive 20 collected on an outer surface of mandrel 14. Also shown in FIG. 9A is knob 90, which is coupled to cutting member 84 with threaded member 92. In the embodiment shown in FIG. 9A, cutting member 84 includes an inclined surface 84A and surface 84B that define tip 94 for piercing through adhesive 20. Cutting member 84 is held relatively stationary relative to mandrel 14 as mandrel 14 is rotated in order to pull adhesive 20 from component 21. As mandrel is rotated in direction 36, cutting member 84 removes adhesive 20 from mandrel 14 with a scraping action. In other embodiments, cutting member 84 may have different configurations. For example, cutting member 84 may define two inclined surfaces.

A user or automated device may engage or disengage cutting member 84 with adhesive 20 as desired. For example, in some embodiments, a sensor may be mounted to base 12 to determine when a particular thickness T of adhesive 20 on mandrel 14 has exceeded a threshold value. Upon detecting that the threshold thickness has been exceeded, a control device may actuate threaded mechanism 92 or another mechanism to advance cutting member 84 toward mandrel 14 to scrape adhesive 20 from mandrel 14. Alternatively, the user may visually gauge the thickness of adhesive 20 on mandrel 14, and may manually engage cutting member 14 with the adhesive 20 on mandrel 14 when desired.

In other embodiments, inclined surface 84A and surface 84B of cutting member 84 may be reversed, as shown in FIG. 9B.

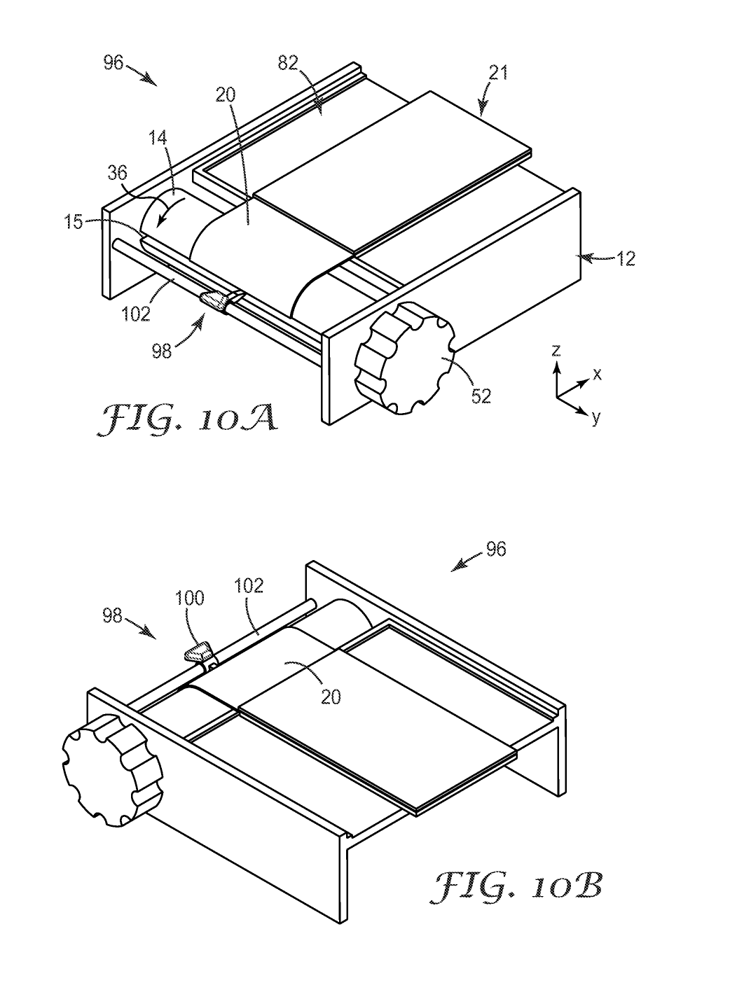

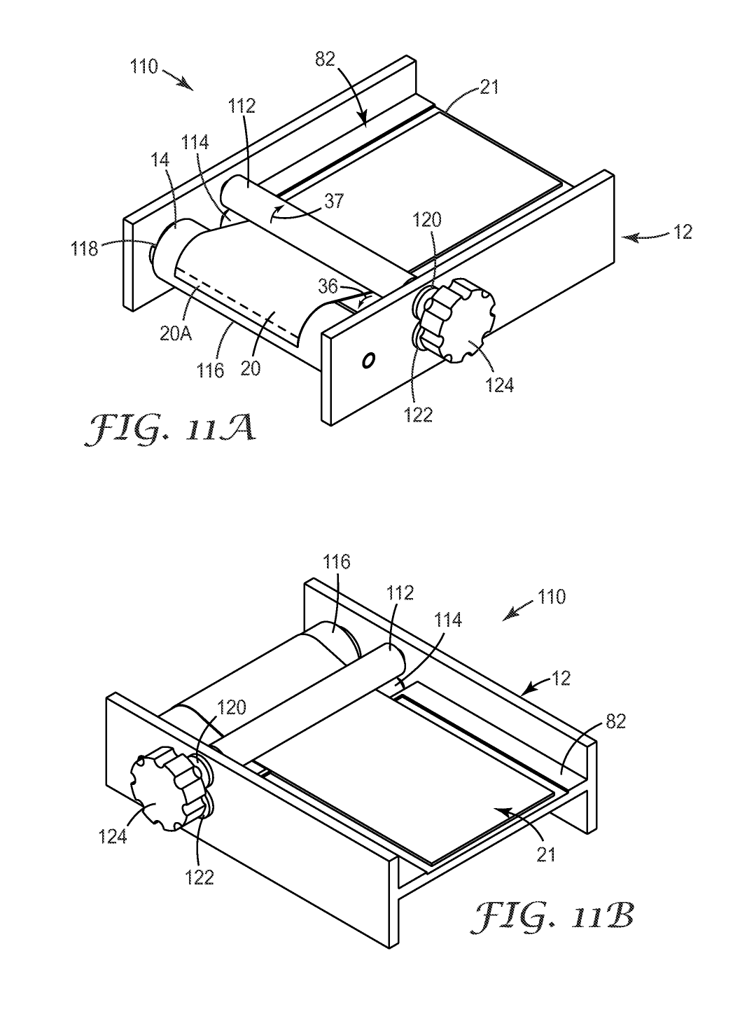

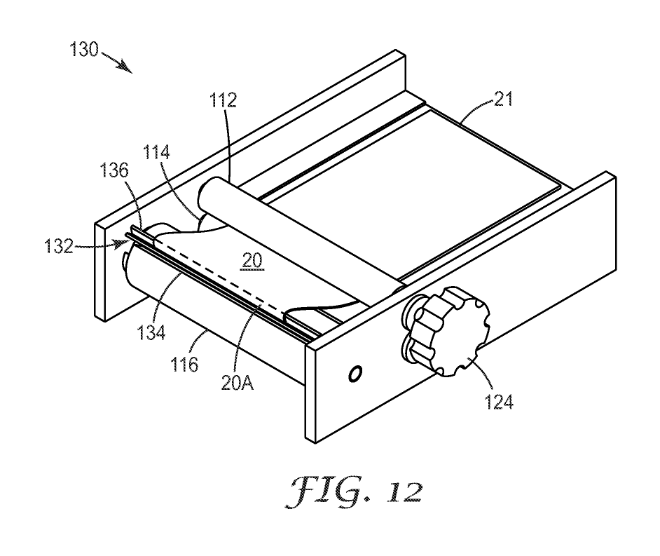

FIGS. 10A and 10B are schematic perspective views of an embodiment of adhesive removal system 96, which is similar to adhesive removal system 80 of FIGS. 8A and 8B, but includes a different embodiment of a cutting system 98. Cutting system 98 includes a cutting member 100 that is movably mounted to track 102, which enables the y-axis position of cutting member 100 to be adjusted. Although track 102 is shown to be coupled to base 12 at a relative stationary position, in other embodiments, track 102 may be movably mounted to base, such that the x-axis position of cutting member 100 may be adjusted. For example, one or more threaded members similar to threaded member 92 (FIG. 9A) may be used to mount track 102 to base 12.

In contrast to cutting member 84 of system 80 of FIGS. 8A-8B, a width of cutting member 100 does not substantially equal the width of mandrel 14 (measured substantially along the y-axis direction). In order to cut the adhesive along the width of mandrel 14 or at least along the width of the adhesive 20, a user or automated device may move cutting member 100 along track 102. In the embodiment shown in FIGS. 10A and 10B, cutting member 100 is received in groove 15 of mandrel 14, thereby enabling cutting member 100 to remove a substantial portion of adhesive 20 from mandrel 14.

Although the adhesive removal systems 10 (FIG. 1), 80 (FIG. 8A), and 96 (FIG. 10A) each include a mandrel to apply a pulling force to adhesive layer 20 in order to stretch and remove adhesive layer from component 21, an adhesive removal system may include other types of adhesive removal members. FIGS. 11A and 11B are schematic perspective views of adhesive removal system 110, which includes nip rollers 112, 114 to apply a pulling force to adhesive layer 20. Nip rollers 112, 114 may also be referred to as friction rollers. Adhesive removal system 110 further includes base 12, platform 82, and spring-loaded collection roller 116, which is coupled to base 12 with spring 118. Although platform 82 is shown in FIGS. 11A and 11B, in other embodiments, system 110 may include other types of platforms to support component 21 or another substrate.

Nip rollers 112, 114 are rotatably mounted to base 12 such that rollers 112, 114 rotate in substantially opposite directions. In particular, nip roller 112 is mechanically coupled to gear 120, which is configured to rotate in direction 37 and nip roller 114 is mechanically coupled to gear 122, which is configured to rotate in a substantially opposite direction 36. In general, “mechanically coupled” indicates that two elements are directly or indirectly attached or connected to each other, which may be accomplished with the use of mechanical mechanisms (screws, nails, clamps, and the like), adhesives, welding (e.g., ultrasonic welding), and any other suitable technique. Gears 120, 122, which may be toothed gears, are engaged with each other, such that rotation of one gear causes rotation of the other gear in a substantially opposite direction. In some embodiments, one of the gears 120, 122 may be a drive gear, and the other gear may be an idle gear that is rotated by the drive gear. Knob 124 is coupled to the drive gear 120 or 122, and a single knob 124 may be rotated in order to rotate both rollers 112, 114 in their respective directions.

In some embodiments, nip rollers 112, 114 are biased toward each other. For example, one roller may be stationary and the other roller may be spring-biased toward the stationary roller. In other embodiments, nip rollers 112, 114 are mounted such that there is a predetermined spacing between outer surfaces of rollers 112, 114. The spacing between rollers 112, 114 may be selected based, for example, the compressive pressure to be applied to adhesive 20 when the adhesive is positioned between rollers 112, 114. For example, the spacing between rollers 112, 114 should be sufficient to engage adhesive 20 in order to pull adhesive 20 through nip rollers 112, 114 and from component 21. On the other hand, the spacing between rollers 112, 114, should be insufficient to bond adhesive 20 to one or both of the rollers 112, 114. The spacing between rollers 112, 114 is relatively consistent in order to help pull adhesive layer 20 through rollers 112, 114 in a substantially even manner, i.e., to apply a relatively uniform pull force to adhesive layer 20 along the side of adhesive layer 20 closest to rollers 112, 114.

As rollers 112, 114 rotate in their respective directions, any material position between rollers 112, 114 is advanced toward collection roller 116. In order to remove adhesive layer 20 from component 21, a user may initially place tab 20A of adhesive layer 20 between nip rollers 112, 114 or on at least one of nip rollers 112, 114. As the user (alone or with the aid of an automated device) rotates knob 124, and, therefore the drive gear 120 or 122, nip rollers 112, 114, which may be compressed toward each other, e.g., via a spring force, pull adhesive layer 20 from component 21. Adhesive 20 that is removed from component 21 by nip rollers 112, 114 may be collected on collection roller 116. Roller 116 is spring-loaded and biased in direction 36. The bias of roller 116 applies tension to adhesive 20 as it leaves nip rollers 112, 114, which enables adhesive 20 to wrap around collection roller 116. In other embodiments, roller 116 may not apply any tension to adhesive 20 and may instead be a passive roller, or adhesive 20 may be collected onto or into device other than a collection roller 116.

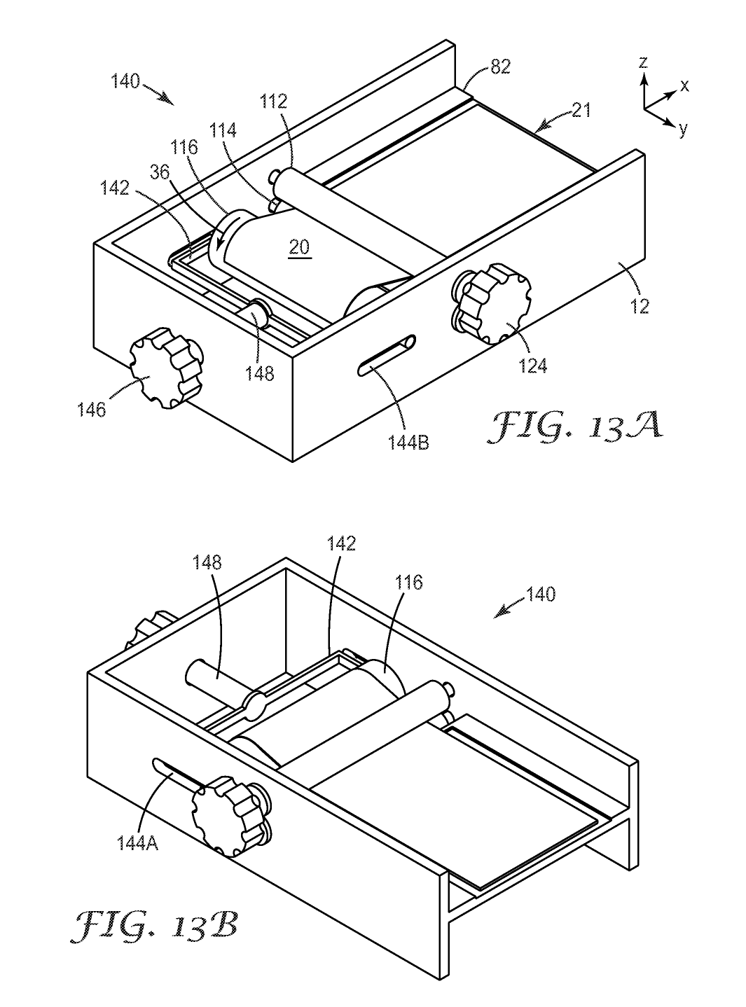

FIG. 12 is a schematic perspective view of adhesive removal system 130, which is substantially similar to adhesive removal system 110 of FIGS. 11A-11B, but includes an insert 132, which is introduced into groove 134 of collection roller 116. Insert 132 exhibits some flexibility and is shaped to at least partially fit within groove 134. A groove 136 defined by insert 132 is larger than groove 134 of collection roller 116. However, when insert 132 is introduced into groove 134 of collection roller 116, insert 132 compresses, thereby effectively decreasing the size of the insert groove 136.

Insert 132 may help customize the size of groove 134 of collection roller 116 to a particular type of adhesive 20 or a particular adhesive thickness. That is, insert 132 defines an indexing clamp for coupling to different amounts of adhesive. For example, tab 20A of adhesive 20 may be introduced into the channel groove 136 of insert 132, and insert 132 may be subsequently introduced into groove 134 of roller 116. As the relatively rigid groove 134 of the roller 116 exerts a compressive force on insert 116, the insert channel 136 decreases in size. This enables insert 132 to clamp onto adhesive tab 20A. Insert 132 may also be used with groove 15 of mandrel 14.

FIGS. 13A and 13B are schematic perspective views of another embodiment of an adhesive removal system 140. Just as with adhesive removal system 110 of FIGS. 11A-11B, adhesive removal system 140 includes base 12, platform 82, which supports component 21 to which adhesive layer 20 is bonded, nip rollers 112, 114 for moving adhesive layer 20 relative to component 21, and collection roller 116 for collecting adhesive 20 that is removed from component 21. However, in contrast to adhesive removal system 110, the collection roller 116 of adhesive removal system 140 shown in FIGS. 13A-13B is movably mounted to base 12. That is, collection roller 116 is movable relative to nip rollers 112, 114 in a direction substantially along the x-axis.

Collection roller 116 is rotatably mounted to bracket 142, which is slidably mounted within channels 144A, 144B defined by base 12. The x-axis position of collection roller 116 may be modified by adjusting the position of bracket 142 along channels 144A, 144B. In the embodiment shown in FIGS. 13A-13B, the position of bracket 142B along channels 144A, 144B may be adjusted by rotating knob 146, which is mechanically coupled to a threaded member 148 that mechanically couples bracket 142 to base 12. Thus, turning knob 146 may either advance collection roller 116 toward nip rollers 112, 114 or away from nip rollers 112, 114. In other embodiments, collection roller 116 may slide along channels 144A, 144B without the aid of a threaded member 148. For example, channels 144A, 144B may define teeth or other protrusions that define preset positions for bracket 142, whereby bracket 142 may be “locked” into place at one of the preset positions by fitting between the teeth or other protrusions. Other techniques for moving collection roller 116 relative to nip rollers 112, 114 and/or securing the position of collection roller 116 relative to nip rollers 112, 114 are contemplated.

It may be desirable to adjust the relative position between collection roller 116 and nip rollers 112, 114 in some situations. For example, collection roller 116 may be moved away from nip rollers 112, 114 if the thickness of adhesive 20 that collects on roller 116 impedes rotation of roller 116 due to interference with nip rollers 112, 114, or if the thickness of adhesive 20 on collection roller 116 impedes rotation of nip rollers 112, 114.

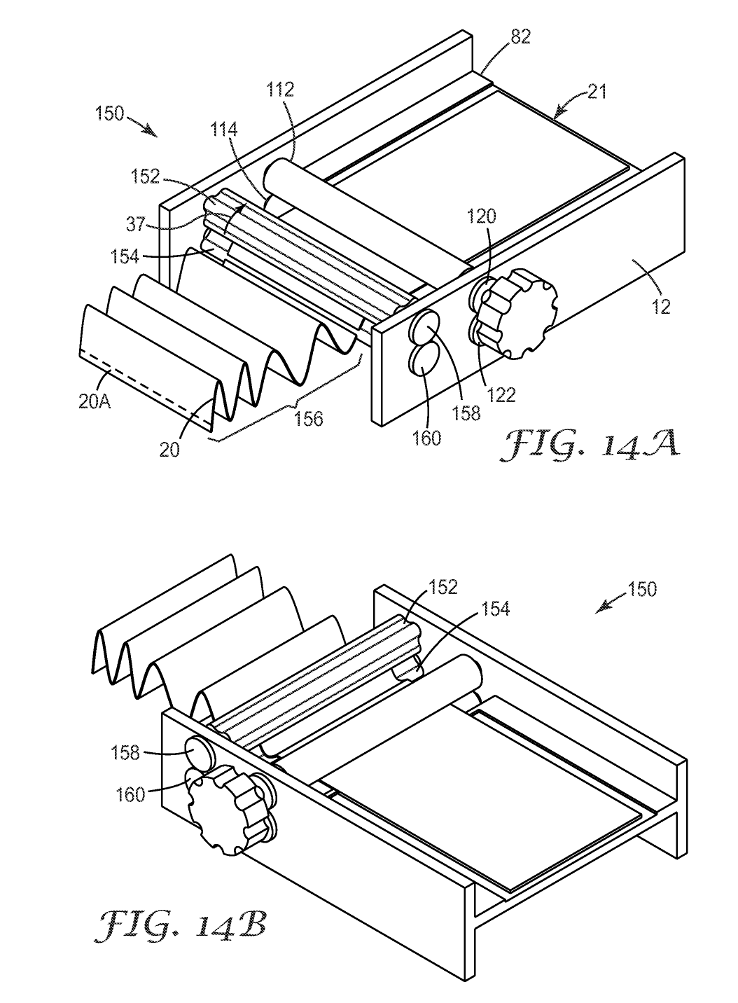

Adhesive 20 that is removed from component 21 may be collected on a mandrel or a collection roller, as described above. In other embodiments, adhesive 20 that is removed from component 21 may be collected using other suitable techniques. FIGS. 14A and 14B are schematic perspective views of adhesive removal system 150, which includes rollers 152, 154 that receive adhesive 20 that is removed from component by nip rollers 112, 114 and folds the adhesive 20 into an accordion-like aggregation (or arrangement) 156. The accordion-like arrangement 156 of the removed adhesive 20 enables the adhesive 20 to be collected into a relatively organized pile, which may be useful for controlling the removed adhesive.

In the embodiment shown in FIGS. 14A and 14B, rollers 152, 154 are rotatably mounted to base 12 in a similar manner as nip rollers 112, 114. In particular, roller 152 is mechanically coupled to gear 158, which is configured to rotate in direction 37 and roller 154 is mechanically coupled to gear 160, which is configured to rotate in a substantially opposite direction. Gears 158, 160, which may be toothed gears, are engaged with each other, such that rotation of one gear causes rotation of the other gear in a substantially opposite direction. Gears 158, 160 may be similar to gears 120, 122 of nip rollers 112, 114. Rollers 152, 154 are indirectly driven by nip rollers 112, 114. Removed adhesive extends between nip rollers 112, 114 and rollers 152, 154. The movement of the removed adhesive 20 as it is advanced through nip rollers 112, 114 and through rollers 152, 154 drives rollers 152, 154. In other embodiments, rollers 152, 154 may include a separate drive device, which may be rotated manually be a user or by an automated device.

As rollers 152, 154 rotate in their respective directions, any material position between rollers 152, 154 is advanced away from rollers 152, 154 and away from nip rollers 112, 114. The structure of outer surfaces of rollers 152, 154 define the arrangement of adhesive 20 in the aggregation 156 of removed adhesive by imparting a shape to the adhesive 20 as the removed adhesive 20 passes between rollers 152, 154. Rollers 152, 154 may be biased toward each other or may be mounted such that there is a predetermined spacing between outer surfaces of rollers 152, 154. The spacing between rollers 152, 154 may be selected based on, for example, the compressive pressure to be applied to adhesive 20 in order to arrange removed adhesive 20 into the accordion-like arrangement 156.

Although rollers 152, 154 are shown with respect to an adhesive removal system that includes nip rollers 112, 114 for drawing the adhesive 20 from component 21, in other embodiments, rollers 152, 154 may be incorporated into other adhesive removal systems described herein.

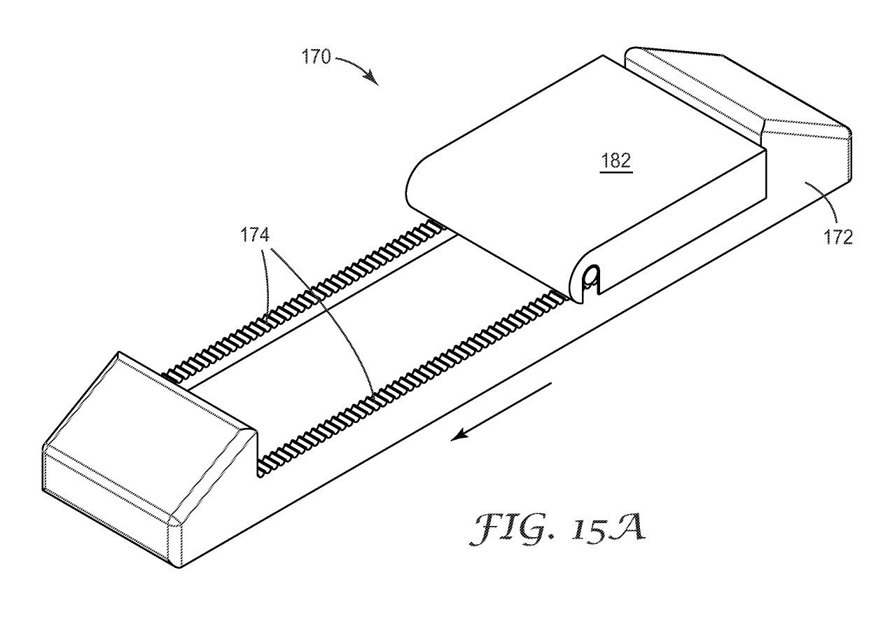

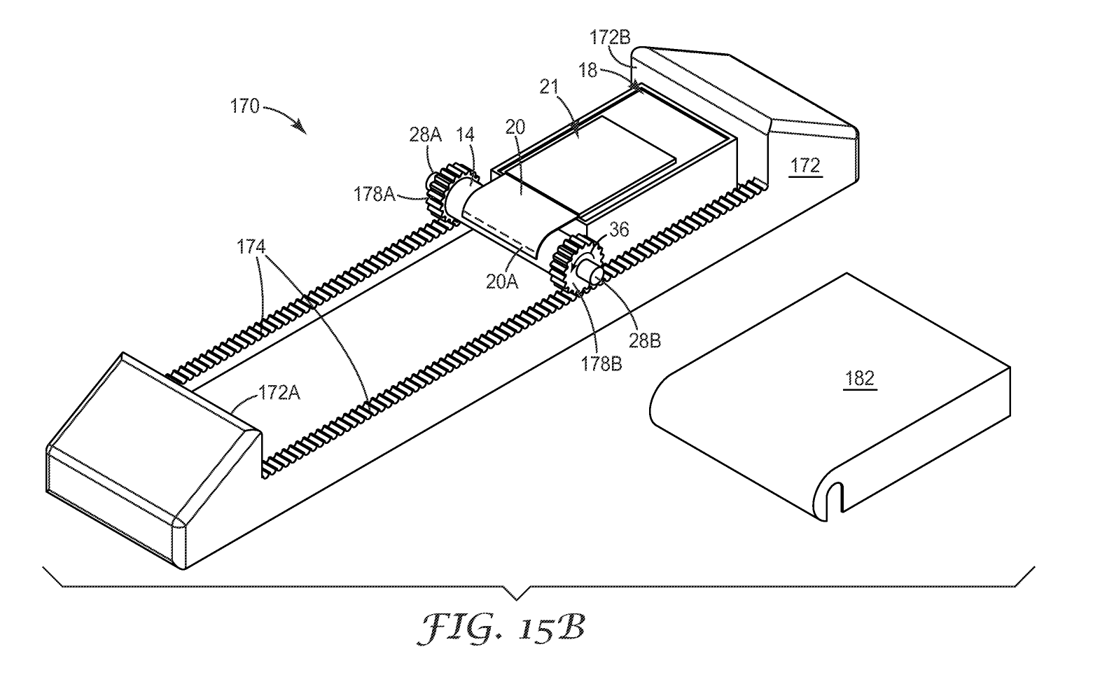

FIG. 15A is a schematic perspective view of another embodiment of adhesive removal system 170 that implements another technique for removing adhesive from a component. FIG. 15B is a schematic exploded view of adhesive removal system 170. Adhesive removal system 170 includes mandrel 14, platform 18, base 172, gear train 174, gears 178A, 178B, and cover member 182. Platform 180 is configured to support component 21 including adhesive layer 20, and may be similar to any of the platforms described above. Platform 18 is slidably mounted in a channel defined by gear train 174.

In the embodiment shown in FIGS. 15A and 15B, base 172 defines gear train 174. For example, base 172 may be a molded or extruded structure, and gear train 174 may be integrally formed with base 172 during the molding or extrusion process. In other embodiments, gear train 174 may be separate from base 172 and coupled to base 172 using any suitable technique, such as an adhesive, welding (e.g., ultrasonic welding), interlocking parts, and the like.

Gears 178A, 178B are mounted to arms 28A, 28B, respectively, of mandrel 14, such that the position between gears 178A, 178B and arms 28A, 28B are substantially fixed. Mandrel 14 may be movably coupled to base 172 by engaging gears 178A, 178B with gear train 174. The teeth of gears 178A, 178B are configured to interlock with teeth of gear train 174. As gears 178A, 178B are rolled along track, mandrel 14 is rotated in direction 36. In this way, gears 178A, 178B drive the movement of mandrel 14. Gears 178A, 178B may each include a rotation limiting member to discourage movement of mandrel 14 in direction substantially opposite to direction 36.

Tab 20A of adhesive layer 20 may be initially bonded, clamped or otherwise coupled to mandrel 14. If component 21 is not placed on platform 18, the user may place component 21 on platform 18. Similarly, if gears 178A, 178B are not on gear train 174, the user may place gears 178A, 178B, along with mandrel 14, on gear train 174 such that the teeth of gears 178A, 178B are interlocked with teeth of gear train 174. Cover member 182 may then be placed over the assembly of the platform 18, mandrel 14, component 21, and gears 178A, 178B.

In order to remove stretch release adhesive 20 from component 21, the user (alone or with the aid of an automated device) may push cover member 182 along gear train 174 and toward an end of gear train 174 that is furthest from component 21, i.e., toward end 172A of base 172. Pushing cover member 182 while gears 178A, 178B are engaged with gear train 174 causes mandrel 14 to rotate, which, in turn, applies a pulling force to adhesive 20 to stretch adhesive 20 and draw adhesive 20 away from component 21. In this way, gears 178A, 178B and gear train 174 support the removal of adhesive 20 from component 21. In addition, pushing cover member 182 from end 172A to end 172B of gear train 174 also pushes platform 18 and component 21 along the length of gear train 174. While gears 178A, 178B and mandrel 14 may be pushed along gear train 174 without the aid of cover member 182, cover member 182 helps to push platform 18, and, therefore, component 21, and mandrel 14 and substantially the same pace. This helps maintain a relatively constant distance between component 21 and mandrel 14.

In some embodiments, the length of gear train 174 (measured substantially along the x-axis direction) may be selected based on the amount of adhesive 20 within component 21. For example, gear train 174 length may be selected such that one traversal across gear train 174 is sufficient to remove substantially all of adhesive 20 from component 21. As another example, the gear train length may be selected such that two or more traversals across gear train 174 are sufficient to remove substantially all of adhesive 20 from component 21. If cover member 182 reaches an end 172A of base 172 before substantially all of adhesive 20 is removed from component 21, the user (alone or with the aid of an automated device) may remove platform 18, mandrel 14, and gears 178A, 178B from gear train 174 and reassemble the platform 18, mandrel 14, and gears 178A, 178B with gear train 174 at the opposite end 172B of base 172 and push the platform 18, mandrel 14, and gears 178A, 178B along gear train 174 from end 172A to end 172B of base 172. This process may be repeated until substantially all or the desired amount of adhesive 20 is removed from component 21.

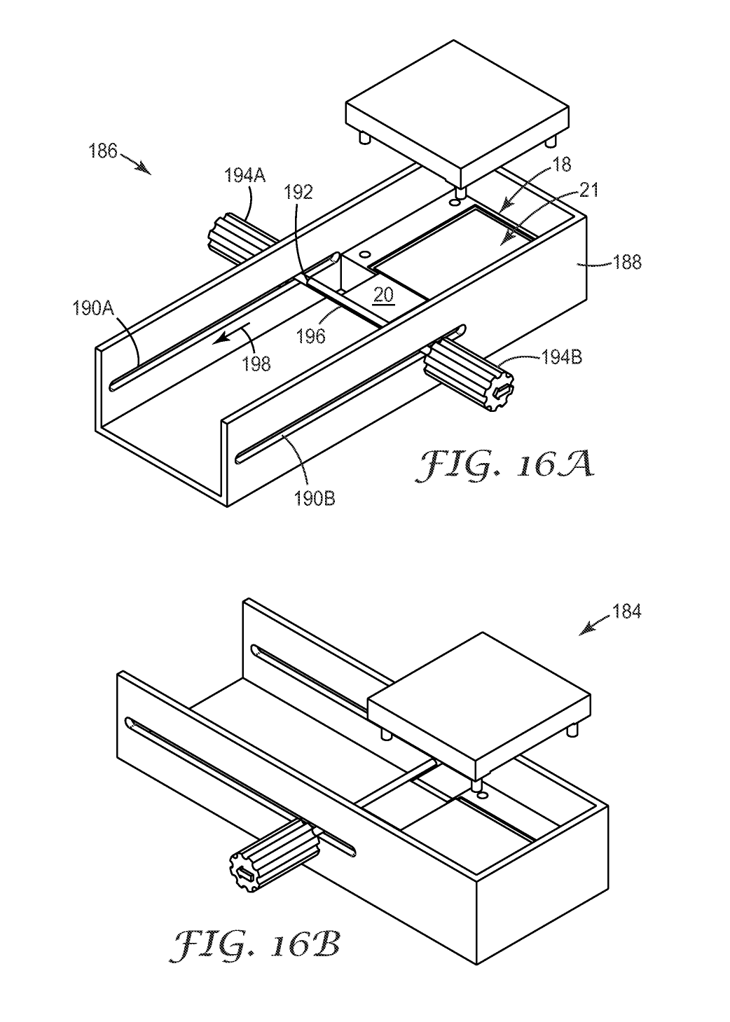

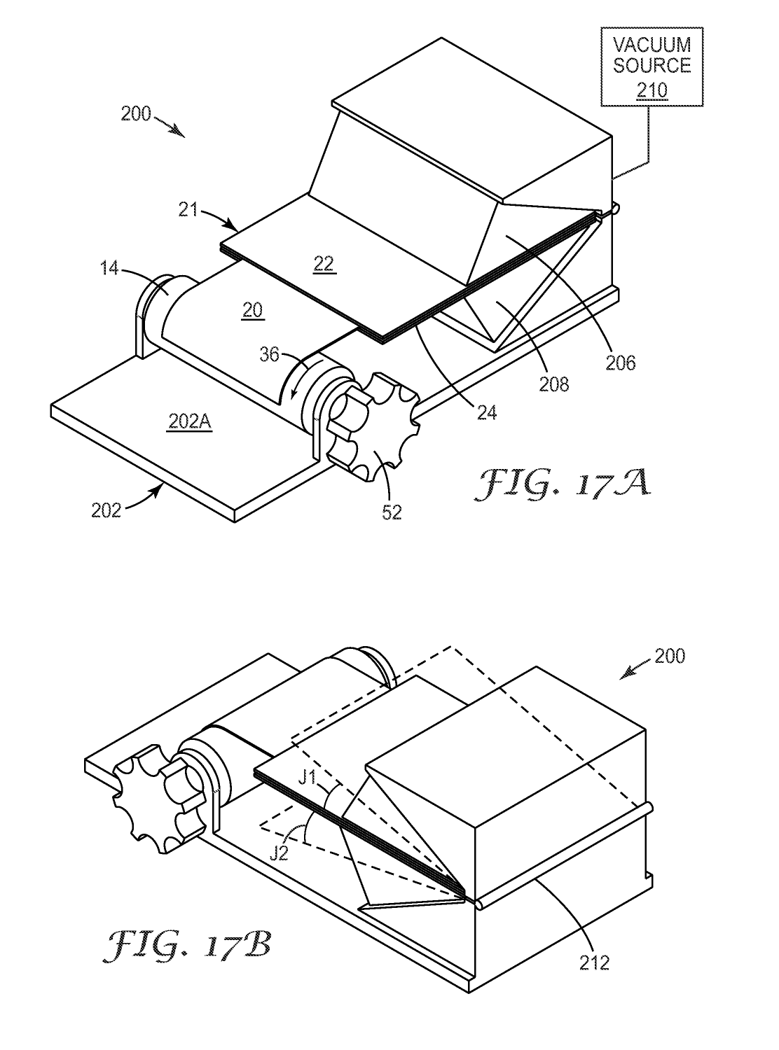

FIGS. 16A and 16B illustrate another embodiment of an adhesive removal system 186, which incorporates another technique for applying a pulling force to adhesive layer 20 that is bonded to component 21. Adhesive removal system 186 includes platform 18, base 188, which defines channels 190A, 190B, and beam 192, which is coupled to handles 194A, 194B. Component 21 is restrained from movement towards beam 192 by platform 18, which is mounted within base 188 at a fixed position. Beam 192 extends across a width of base 188 (measured along the y-axis direction) and through channels 190A, 190B. Beam 192 is slidably mounted in channels 190A, 190B, and, therefore, beam 192 may be moved along the x-axis direction relative to platform 18. Handles 194A, 194B are attached to ends of beam 192, at a fixed position relative to beam 192. Handles 194A, 194B provide a surface for handling beam 192, as well as help prevent beam 192 from sliding out of channels 190A, 190B.

Beam 192 includes a clamping mechanism 196 that mechanically couples adhesive 20 to beam 192. For example, tab 20A (not shown in FIG. 16A) of adhesive 20 may be introduced into clamping mechanism 196. In other embodiments, adhesive 20 may be directly adhered to beam 192 without the aid of another mechanically coupling mechanism, or other mechanical coupling mechanisms may be used to attach adhesive 20 beam 192. In order to stretch adhesive 20 and draw adhesive 20 away from component 21, beam 192 may be slid along channels 190A, 190B, as indicated by arrows 198. Because platform 18 and component 21 are held in a fixed position, a pulling force is applied to adhesive 20 as beam 192 is moved away from platform 18. Beam 192 may be slid along channels 190A, 190B until the desired amount of adhesive 20 is removed from component 21. Accordingly, the length of channels 190A, 190B (measured substantially along the x-axis direction) may be based on the amount of adhesive to be stretched and removed from component 21.

FIGS. 17A and 17B are schematic perspective views another embodiment of an adhesive removal system 200, which utilizes vacuum force to hold component 21. System 200 includes mandrel 14, base 202, first vacuum arm 206, second vacuum arm 208, and vacuum source 210. Mandrel 14 is rotatably mounted to base 202. As previously described, mandrel 14 may be rotated in direction 36 by rotating knob 52. Mandrel 14 may also exhibit limited rotation in a direction substantially opposite direction 36.

Rather than holding component 21 in a relatively fixed position relative to mandrel 14 with the aid of a platform (e.g., platform 18 of FIGS. 1-2), vacuum arms 206, 208 of adhesive removal system 200 hold component 21. In the embodiment shown in FIGS. 17A and 17B, vacuum arm 206 applies a vacuum force to glass plate 22, while vacuum arm 208 applies a vacuum force to LCD module 24. One or more fluid channels within arms 206, 208 that are in fluid communication with vacuum source 210 provide the suction source. The vacuum force applied by arms 206, 208 to component 21 helps restrain movement of component 21 towards mandrel 14 as mandrel 14 is rotated to stretch adhesive 20 and remove adhesive 20 that is positioned between glass plate 22 and LCD module 24.

The vacuum force applied by arms 206, 208 is relatively gentle, which helps preserve glass plate 22 and LCD module 24 of component 21 for reuse. Arms 206, 208 are biased in a direction substantially away from each other, e.g., with the aid of spring 212. After adhesive 20 is removed from component 21, arms 206, 208 may spring away from each other, thereby separating glass plate 22, which is coupled to arm 206, and LCD module 24, which is coupled to arm 208. In this way, spring biased arms 206, 208 may help glass plate 22 and LCD module 24 from contacting each other. Contact between glass plate 22 and LCD module 24 which may damage or at least adversely impact the performance of glass plate 22 and/or LCD module 24.

Although spring 212 is not necessary, spring 212 helps to minimize any compressive forces that may be exerted on component 21, which may push glass plate 22 and LCD module 24 and increase the adhesion between adhesive 20 and bond surfaces of component 21. In some cases, the removal of adhesive 20 may be aided by the biased arms 206, 208 because arms 206, 208 help to pry glass plate 22 and LCD module 24 apart, which may help release adhesive 20 from glass plate 22 and LCD module 24. In addition, applying a force that encourages movement of glass plate 22 away from LCD module 24 may help prevent adhesive 20 from re-adhereing to either glass plate 22 or LCD module 24 by maximizing the space between glass plate 22 and LCD module 24.

Arms 206, 208 are not rigidly held in place relative to base 202, which allows component 21 to generally pivot about spring 212, in a direction indicated by arrow 214 when held in place by arms 206, 208. In one embodiment, arms 206, 208 are configured to permit component 21 to pivot angle J1 in a first direction relative to a baseline position of component 21 when arms 206, 208 are in a baseline position, and angle J2 in a second direction relative to a baseline position of component 21. The baseline position of component 21 may be achieved when no external forces are applied to arms 206, 208 in order to change the position of arms 206, 208, which is shown in FIG. 17B. In one embodiment, in the baseline position of arms 206, 208, glass plate of component 21 is substantially parallel to a major surface 202A of base 202. Angles J1 and J2, illustrated in FIG. 17B, may each be in a range of about 10 to about 350, although other pivot angles are possible in other embodiments. FIG. 17B also illustrates, in phantom lines, the positions of component 21 when pivoted at angles J1 and J2.

As the thickness of removed adhesive 20 on mandrel 14 increases, component 21 may pivot to maintain a tangential alignment with the outer surface of the adhesive collected on mandrel 14. In this way, adhesive removal system 200 may readily adapt to changes in the angle at which adhesive 20 is pulled from component 21. As discussed above, it may be undesirable for adhesive 20 to be withdrawn from component 21 at particular angles because it may increase the possibility of adhesive 20 re-adhering to a surface of component 21 or the possibility of adhesive 20 breaking.

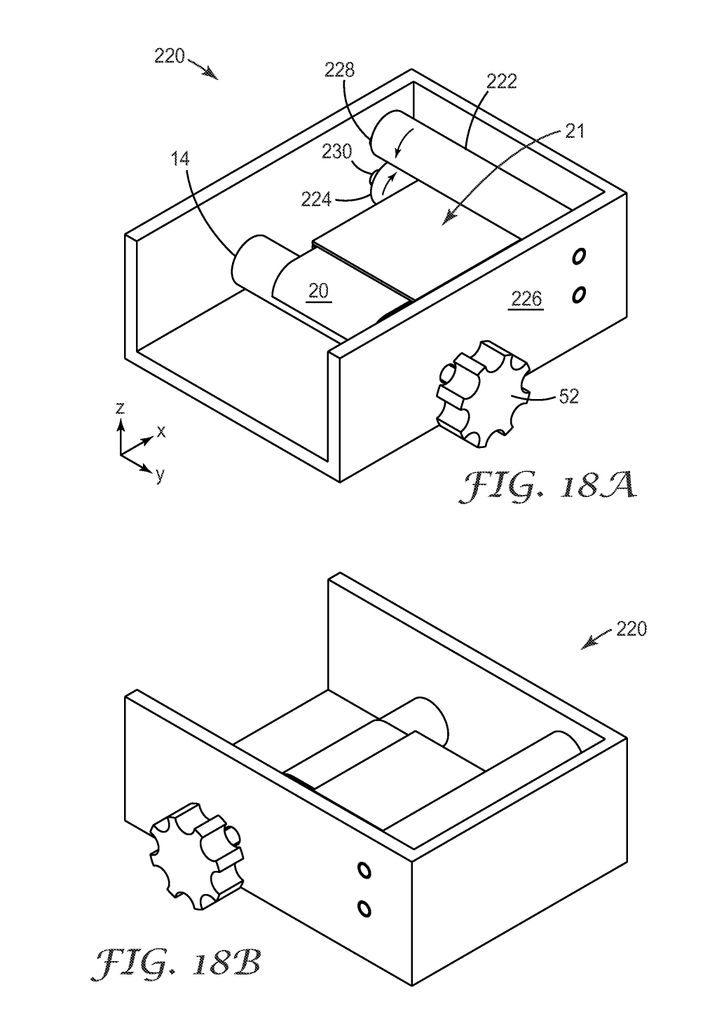

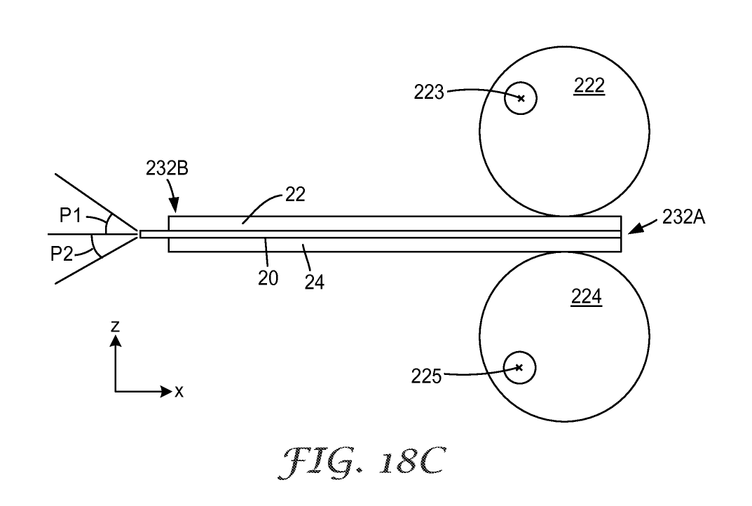

FIGS. 18A and 18B are schematic perspective views of another embodiment of an adhesive removal system 220, which includes cam rollers 222, 224 that hold component 21 in place relative to mandrel 14. Adhesive removal system further includes mandrel 14, which is rotatably mounted to base 226, and knob 52, which is coupled to mandrel 14. Rollers 222, 224 are rotatably mounted to base 226 by gears 228, 230, such that roller 222 rotates in direction 36 and roller 224 rotates in a substantially opposite direction. Component 21 may be pushed between cam rollers 222, 224, which hold component 21 by friction fit. Rollers 222, 224 may be biased against each other in order to permit cam rollers 222, 224 to apply a compressive pressure to component 21 to help restrain movement of component 21 relative to mandrel 14. Gears 228, 230 may include a rotation limitation mechanism, such as a ratchet mechanism, that helps limits rotation of roller 222 in a direction towards mandrel 14 and limits rotation of roller 224 in a direction away from mandrel 14 (i.e., direction 36). In some embodiments, gears 228, 230 may lock in order to help prevent rotation of rollers 222, 224 while component 21 is positioned between rollers 222, 224.

FIG. 18C is a schematic side view of cam rollers 222, 224 and component 21, which is fixed between rollers 222, 224. Cam roller 222 has an offset axis of rotation 223 (i.e., axis of rotation 223 is not centered), and cam roller 224 has an offset axis of rotation 225. Cam rollers 222, 224 have a limited range of motion as a result of the offset axes of rotation 223, 225. Because one end 232A of component 21 is fixed between cam rollers 222, 224 and the opposing end 232B of component 21 is unrestrained, component 21 may pivot angles P1 and P2 relative to a major surface of glass plate 22. Angles P1 and P2 may each, independently, be in a range of about 1° to about 35°. As previously indicated, in some cases, it may be desirable for component 21 pivot in order to help maintain a tangential alignment with the outer surface of any removed adhesive that has collected on mandrel 14. In this way, cam rollers 222, 224 may readily adapt the position of component 21 as the angle at which adhesive 20 is pulled from component 21 changes (i.e., as the thickness of adhesive collected on mandrel 14 increases).

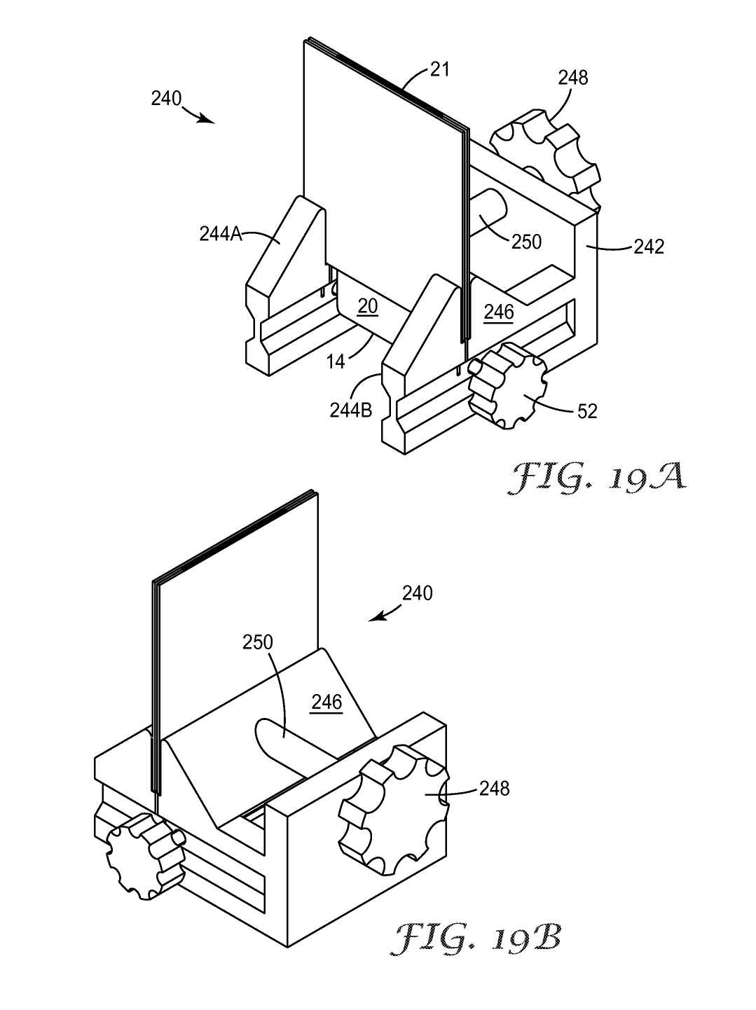

FIGS. 19A-19B are schematic perspective views of another embodiment of an adhesive removal system 240, which includes mandrel 14, mandrel knob 52, base 242, clamping members 244A, 244B, 246, clamp knob 248, and threaded member 250. When component 21 in fixed place relative to mandrel 14, a major surface of component 21 substantially extends along the z-axis direction. As shown in FIGS. 19A and 19B, component 21 is engaged between clamping members 244A, 244B and 246.

Clamping members 244A, 244B may be fixed in place, while clamping member 246 is movable along the x-axis direction with the aid of threaded member 250. In particular, clamping member 246 and knob 248 may be mechanically coupled to opposing ends of threaded member 250, which extends through an opening in base 242. As knob 248 is rotated in a first direction, clamping member 246 advances toward clamping members 244A, 244B and as knob 248 is rotated in a second direction, clamping member retreats from clamping members 244A, 244B. Threaded member 250 may be threaded along its entire length, or may be partially threaded. In other embodiments, a different mechanism for moving clamping member 246 may be used in adhesive removal system 240. However, the configuration of threaded member 250 inherently helps secure a position of clamping member 246.

It may be desirable to maintain alignment between component 21 and mandrel 14 in order to help prevent adhesive of adhesive layer 20 from tearing or otherwise breaking as it is stretched and drawn away from component 21. That is, it may be desirable for adhesive layer 20 to be aligned with an outer surface of mandrel 14 (or an outer surface defined by removed adhesive collected on mandrel 14) such that adhesive layer 20 does not re-adhere to either glass plate 22 or LCD module 24 as adhesive layer 20 is pulled from component 21 or so that adhesive layer 20 does not contact an edge of component 21 that may break adhesive layer 20. In order to help maintain a particular alignment between mandrel 14 and component 21, mandrel 14 may be adjustably mounted to base 242 such that mandrel 14 is movable along the x-axis. A user or automated device may position mandrel 14 based on the location of adhesive layer 20 between clamping members 244A, 244B and 246. The location of adhesive layer 20 may change, depending on the thickness of the other elements of component 21, which may vary depending on the component type. Accordingly, an adjustable mandrel 14 may help customize adhesive removal system 240 to different types of components.

In other embodiments, clamping members 244A, 244B may be movable along the x-axis direction in addition to clamping member 246. Clamping members 244A, 244B, 246 may be self-centering. That is, in some embodiments, as threaded member 250 is rotated in the first direction, clamping members 244A, 244B and clamping member 246 may move toward each other while maintaining a common center point, which is selected based on the desired alignment between adhesive layer 20 and mandrel 14.

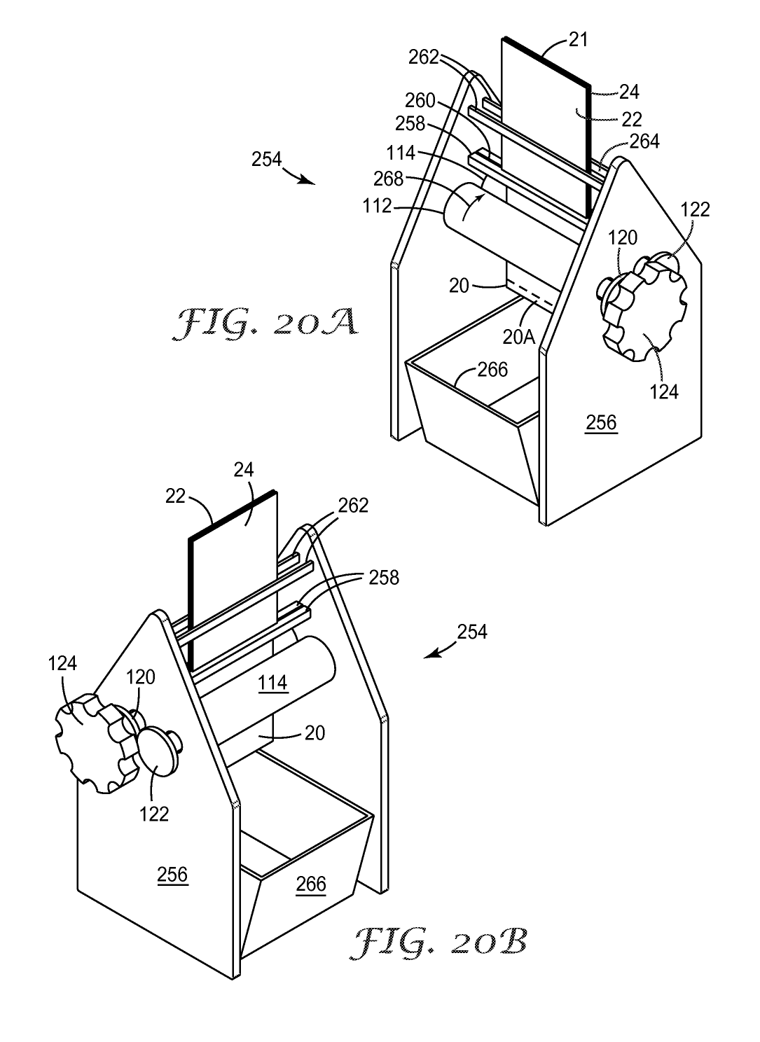

FIGS. 20A and 20B are schematic perspective views of another embodiment of an adhesive removal system 254, which includes nip rollers 112, 114, gears 120, 122, roller knob 124, base 256, first support member 258 defining an opening 260, second support member 262 defining an opening 264, and collection bin 266. Nip rollers 112, 114 are oriented in a different direction relative to each other compared to the embodiment of the adhesive removal system 110 shown in FIGS. 11A and 11B. However, just as in adhesive removal system 110, rotation of nip rollers 112, 114 of adhesive removal system 254, with the aid of the respective gears 120, 122, advances adhesive 20 away from component 21 and causes a substantially even pulling force to be applied across the width W1 of adhesive layer 20. When the force is applied to adhesive 20 while movement of component 21 is restrained, adhesive 20 is stretched and drawn away from the bond surfaces of component 21.

First support member 258 supports glass plate 22 and LCD module 24 of component 21 such that adhesive layer 20 is aligned with opening 260 of first support member 258. Opening 260 is sized to receive adhesive layer 20, such that adhesive layer 20 may extend through opening 260 while glass plate 22 and LCD module 24 of component 21 remain engaged with support member 258. In this way, adhesive layer 20 may be removed from component 21 while a position of component 21 remains substantially fixed. Second support member 262 helps support a different portion of component 21, e.g., to maintain the z-axis orientation of component 21. Opening 264 defined by second support member 262 is sized to receive component 21.

In order to remove adhesive 20 from component 21, a user may introduce component 21 into support members 258, 260 such that tab 20A defined by adhesive layer 20 extends through opening 260 in first support member 258. The user may stretch adhesive layer 20 to feed tab 20A through nip rollers 112, 114. For example, the user may stretch adhesive layer 20 to engage tab 20A with at least one of nip rollers 112, 114, and rotate knob 224 to rotate gear 120, and, therefore, nip roller 112 in a first direction, indicated by arrow 268, which drives gear 122 to rotate nip roller 114 in a second direction, indicated by arrow 269, which is substantially opposite direction 268. As nip rollers 112, 114 rotate in their respective directions, adhesive layer 20 may be advanced through nip rollers 112, 114 and stretched and pulled from component 21. Adhesive that is removed from component 21 and advanced through nip rollers 112, 114 may collect in collection bin 266. As shown in FIGS. 20A and 20B, base 256 may be configured to fit around collection bin 266. In other embodiments, however, base 256 may couple to a top of collection bin 266. Other arrangements between base 256 and collection bin 266 are contemplated.

Glass plate 22 and LCD module 24, which remain engaged by support members 258, 260 after adhesive 20 is removed from component 21, may be recycled or discarded.

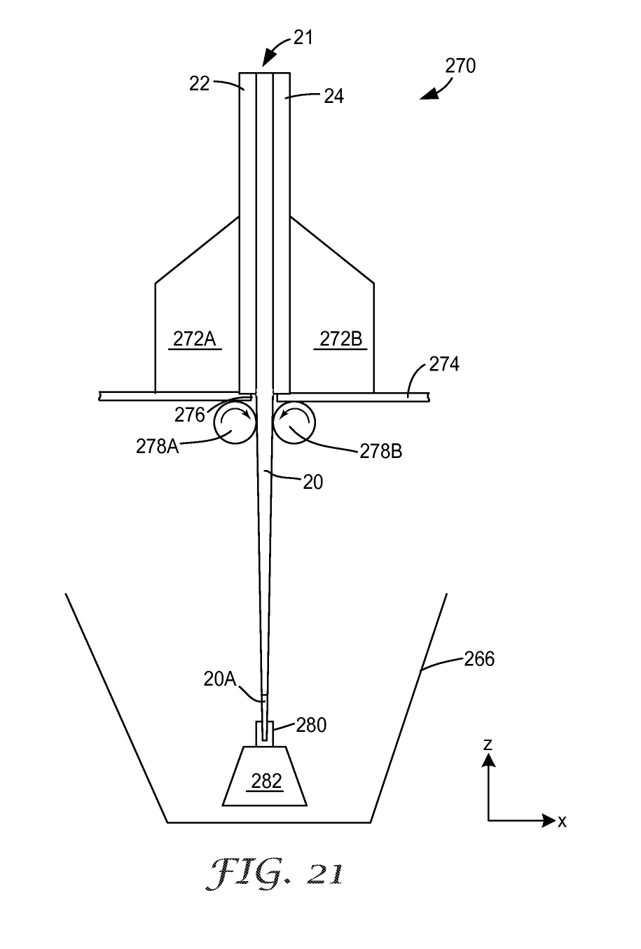

FIG. 21 is a schematic side view of another embodiment of adhesive removal system 270, which includes clamping members 272A, 272B, support member 274 defining opening 276, rollers 278A, 278B, clamp 280, and weight 282. In FIG. 21, component 21 is placed on support member 274 such that adhesive layer 20 is aligned with opening 276. Clamping members 272A, 272B hold component 21 and help restrain component 21 against motion. Clamping members 272A, 272B may be self-centering relative to opening 276. Weight 282 is attached to adhesive layer 20 substantially along width W1 (shown in FIG. 20A) of adhesive layer 20 with the aid of clamp 280. In order to stretch adhesive layer 20 and draw adhesive layer 20 away from component 21, weight 282 may be released in a negative z-axis direction, such that weight 282 falls toward collection bin 266 with the aid of gravity. As weight 282 falls in the negative z-axis direction, a substantially even pulling force is applied across width W1 of adhesive layer 20, thereby stretching adhesive 20 and removing adhesive 20 from component 21. The mass of the weight may be selected to apply a sufficient pulling force to adhesive 20 to stretch adhesive 20 and draw adhesive 20 away from component 21.

Rollers 278A, 278B may be similar to nip rollers 112, 114 and help apply a pulling force to adhesive 20 in addition to weight 282. In other embodiments, rollers 278A, 278B may be passive rollers that help guide adhesive 20 in the negative z-axis direction as weight 282 applies a pulling force to adhesive layer 20.

Instead of or in addition to rollers 278A, 278B and/or weight 282 to apply a pulling force to adhesive layer 20, support member 274 may be moved in a positive z-axis direction in order to apply a pulling force to adhesive 20. For example, while tab 20A of adhesive layer 20 is attached to weight 282 or is substantially fixed (e.g., with the aid of clamping members), support member 274 may be advanced in the positive z-axis direction, thereby separating component 21 from adhesive layer 20, which is substantially fixed in place or is moving in the negative z-axis direction. In other embodiments, other suitable techniques for moving component 21 relative to tab 20A of adhesive layer 20 may be implemented. For example, component 21 may be fed through nip rollers that advance component 21 in a direction substantially away from the end of adhesive layer 20 comprising tab 20A, while tab 20A is fixed in place or coupled to a weight 282.

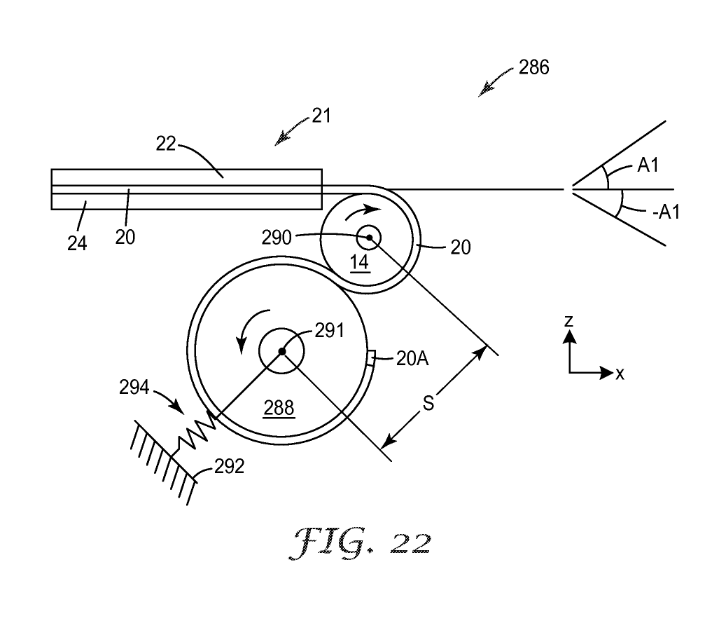

FIG. 22 is a schematic side view of a system 286 that may be used in any adhesive removal systems including a collection roller 288 in order to help maintain a particular orientation between the portion of adhesive layer 20 being removed from component 21 and mandrel 14 or another type of rotating adhesive removal member. Mandrel 14 is configured to rotate in a first direction substantially away from component 21 in order to help apply a pulling force to adhesive layer 20 and stretch adhesive layer 20. Collection roller 288 is configured to rotate in a second direction (e.g., the clockwise direction in FIG. 22), which is substantially opposite the direction of rotation of mandrel 14, and adhesive 20 that is removed from component 21 is wrapped around the outer surface of the substantially cylindrical collection roller 288. As adhesive 20 wraps around collection roller 288, the spacing S between a center rotational axis 290 of mandrel 14 and a center rotational axis 291 of collection roller 288 increases. In order to help prevent mandrel 14 from moving relative to component 21 in order to compensate for any removed adhesive that accumulates on collection roller 116, the center rotational axis 290 of mandrel 14 may be substantially fixed. A fixed center rotational axis 290 of mandrel 14 also enables the angle at which adhesive layer 20 is pulled from component to remain within about angle Al relative to a major surface of component 21 to which adhesive 20 is adhered (e.g., a major surface of glass plate 22 or LCD module 24). Angle A1 may be in a range of about 1° to about 36° in a first direction or in a second, substantially opposite direction, as indicated by angle “−A1” in FIG. 22, although other angles are contemplated.

To compensate for the thickness of removed adhesive that accumulates on collection roller 288, collection roller 288 is fixed to surface 292 with spring 294. Surface 292 may be any suitable surface, such as a surface of an adhesive removal system base. Spring 294 may compress to allow center rotational axis 291 of collection roller 288 to move toward surface 292 as the thickness of any adhesive accumulated on collection roller 288 increases. Movement of collection roller 288 toward surface 294 increases the distance S between center axis of rotation 290 of mandrel 14 and center axis of rotation 291 of collection roller 288.

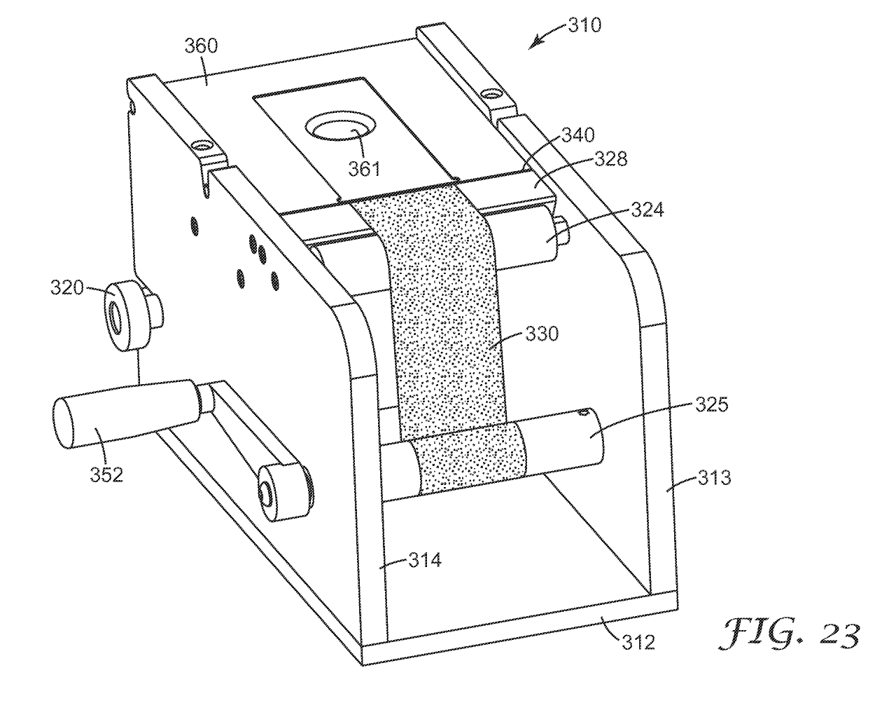

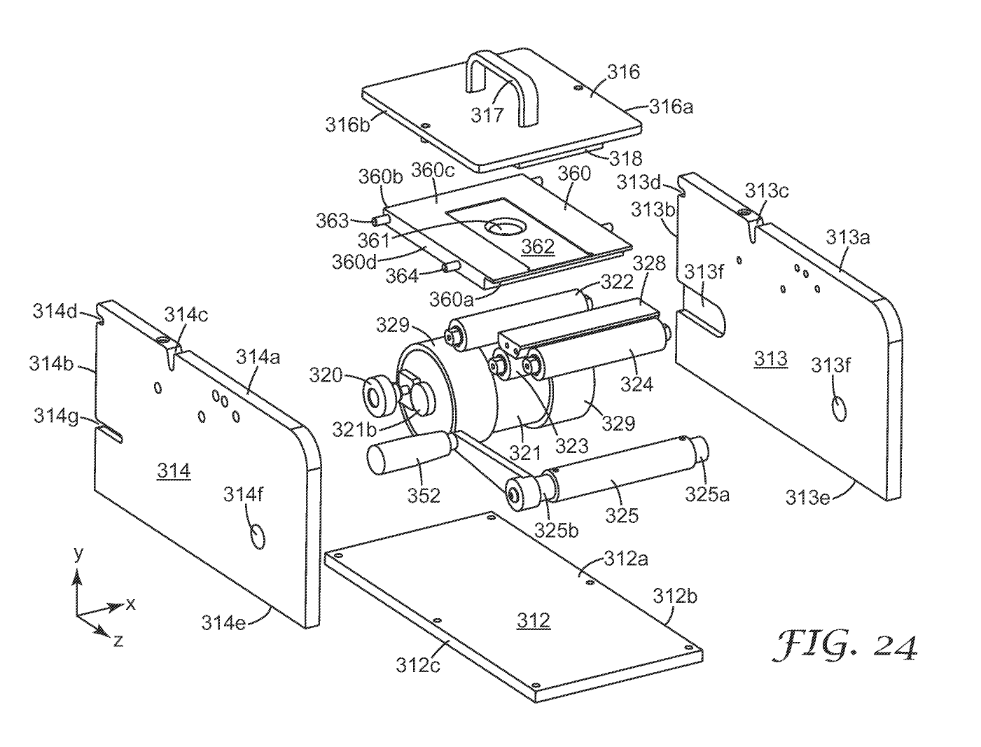

FIG. 23 shows an adhesive removal device 310 having a base 312, a first side wall 313 disposed on one edge of the base, a second side wall 314 disposed on a second edge of the base, a platform 360 straddling between and attached to the first and second side walls. A support plate 328, disposed adjacent to the platform, also straddles between and attaches to the first and second side walls. In this embodiment, a gap 340 lies between the support plate and the platform 360. The combination of the base, first and second side walls, and the platform form a cavity that houses a means for supplying a carrier tape 330 to the support plate 328. The device further includes a crank handle 352 for advancing the carrier tape 330. In one embodiment, the crank handle moves only in one direction, e.g., in a forward direction from the perspective view as shown in the figure. The platform 360 can optionally include an aperture 361 disposed near its center.

FIG. 24 shows an exploded view of the embodiment of FIG. 23 illustrating the details of components housed inside the cavity. The base 312 has a top surface 312a and substantially parallel opposing first and second edges 312b, 312c. The first side wall 313 has a top edge 313a, a back edge 313b and a bottom edge 313e. The first side wall is disposed on the base such that the bottom edge 312e of the first side wall contacts the top surface 312a near the first edge 312b of the base. The second side 314 has a top edge 314a, a back edge 314b and a bottom edge 314e. The second side wall is disposed on the base such that the bottom edge 314e of the first side wall contacts the top surface 312a near the second edge 312c of the base.

The platform and the support plate straddle between and, once assembled, become attached to the first and second side walls. The platform 360 has a top surface 360c with a recess 362 for holding a substrate and stretch release adhesive (not shown). Optionally, the platform includes first and second pairs of pins 363, 364 disposed along its side edges 360d. Once assembled, these pairs of pins mate with features on the first and second side walls. For example, first set of pins 363 couples with first groove 313d on the first side wall and second groove 314d on the second side wall, both the grooves being located on the respective back edges of the side walls 313b and 314b. Second pair of pins 364 couples with first notch 313c on the top edge 313a of the first side wall 313 and with second notch 314c on the top edge 314a of the second side wall 314. With this design, a user can easily interchange platform with different sized recesses. For example, the recess may be configured to receive at least a portion of a liquid crystal display (LCD) display from various mobile hand held devices, such as mobile phones, portable digital music player, personal digital assistant or a portion of an LCD from a laptop computer. The depth of the recesses would be adjusted for the appropriate application. Although the recesses are shown in rectangular shapes, other shaped configurations may be used. In this particular embodiment, the platform also includes a lip 360a that lies distal to a back edge 360b and proximate to support plate 328. There is a gap between the lip 360a of the platform and the support plate 328 to allow for the carrier tape to be threaded through.

FIG. 24 also show the various rollers that lie in the cavity created when the base 312, first side wall 313, second side wall 314, and platform 360 are assembled so as to form the adhesive removal device 310. In this embodiment, there are five different rollers, a first unwind roller 321, a second idler roller 322, a third idler roller 323, a fourth idler roller 324, and a fifth take-up roller 325. Each of the rollers straddle between the first and second side walls, and once assembled, are attached thereto. The second, third and fourth are located nearer to the top surface of the two side walls 313a, 313b while the first and fifth roller are located closer to the base. Thus, using the coordinate system shown in FIG. 24, the second, third and fourth rollers lie more positive on the y-axis as compared to the first 321 and fifth roller 325. Furthermore, the support plate 318 straddles between the third 323 and fourth 324 rollers.

The first roller 321 includes two cylindrical sleeves 329 that can vary in height to accommodate different size of carrier tape. For example, cylindrical sleeves for a 1 inch tape would have a larger height than that used for a 2 inch tape. Typically the sleeves are equal in height to allow the carrier tape to be aligned with the centerline of the device. On both side of the first roller 321, there are mechanical features that facilitate its installation to the first and second side wall 313, 314. For example, the first roller 321 includes a pair of arms, first (not shown) and second 321a arm that slideably engages with first slot 313f and second slot (not shown). Because the first roller sits in the vicinity of the back edge of the two side walls 313, 314, as shown in FIG. 2, the slots begin at the back of the side wall. The first roller 325 also includes an optional knob 320 to allow a user to tighten the first roller in position. As shown in FIG. 23, the knob 320 slideably engages with slit 314g on the second side wall 314.

The fifth roller 325 includes first and second arms 325a, 325b that couples with first aperture 313f on the first side wall 313 and second aperture 314f on the second side wall 314. The crank handle 352 attaches to the second arm 325b.

The device optionally includes a cover 316 having pins located near first and second side edges 316a and 316b that couple with holes on the top surface 313a, 314a of the first and second side walls. The cover can include a bar 318 that lies nearly on top of the support plate 328 towards the gap 340 once the cover is placed on the side walls. The cover optionally includes a handle 317 to facilitate easy lifting and attaching to the side walls.

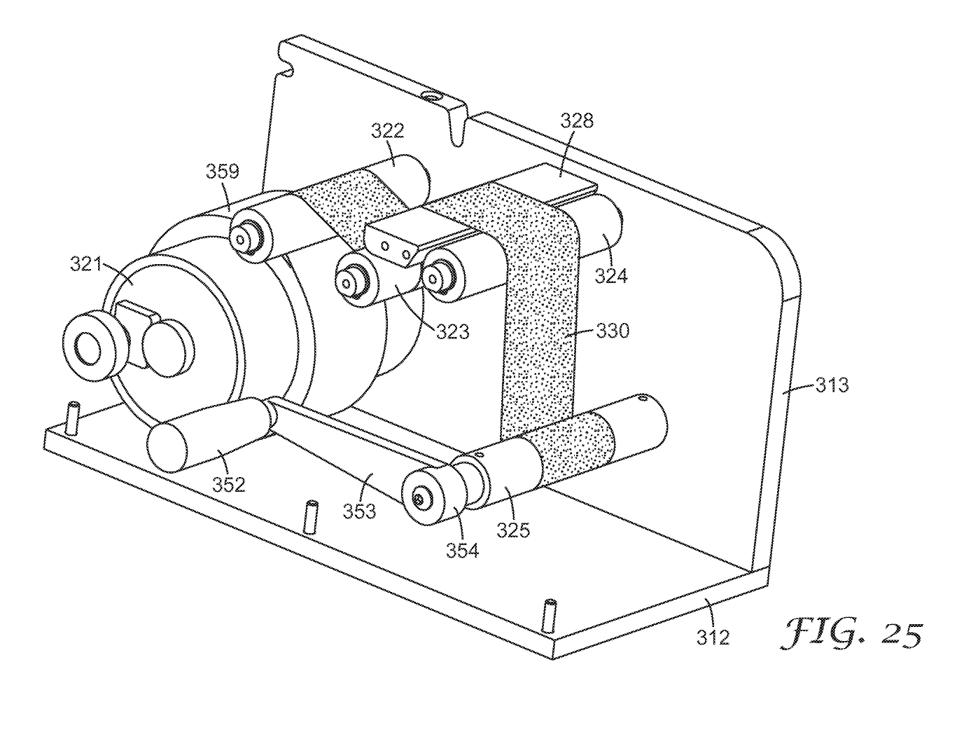

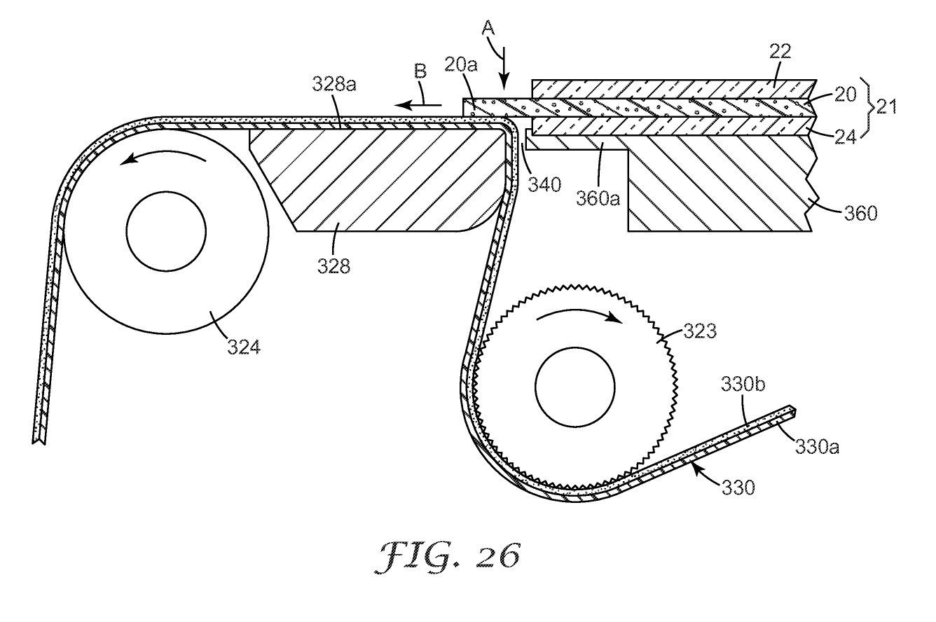

FIG. 25 shows a side-view of the device with the second side wall removed to better illustrate the relative positions of rollers one through 5 in relation to the support plate 328 and also to illustrate the path of the carrier tape 330. FIG. 26 shows a cross-section view of a portion of the device with a stack 21 mounted on the platform 360 with the carrier tape 330 having an adhesive 330b coated on a backing 330a. As shown in FIG. 25, a roll 359 of carrier tape is mounted on the first unwind roller 321. The carrier tape passes over second roller 322 with the backing 330a in contact with a portion of the second roller's circumference. The carrier tape passes over third roller 323 with the adhesive 330b in contact with the circumference of the third roller. Thus, the circumference of the third roller should not adhere to the adhesive. In one embodiment, the circumference of the third roller contains microstructures, such as linear grooves or pyramids. In another embodiment, the circumference of the third roller is coated with a material that does not adhere to the adhesive 330b of the carrier tape. The carrier tape then passes over the support plate 328 with the adhesive 330b exposed and moves over the fourth roller 324, again with the adhesive exposed so that the backing 330a is in direct contact with the circumference. The carrier tape is then wound up by fifth take-up roller 325.

Now turning to FIG. 26, the stack 21 contains two substrates 22 and 24 bonded together by stretch release adhesive 20. In one embodiment one of the substrate can be glass plate while the other is a LCD module, which may include a respective glass plate, an LCD element (including liquid crystals), and a tough panel. In another embodiment, each of the two substrates can be glass plate or a glass plate and a touch panel display. The stretch release adhesive 20 includes a tab 20a. In use, the carrier tape is held in tension over a top surface 328a of the support plate 328 between the various rollers. FIG. 4 only shows third roller 323 and fourth roller 324 for ease of understanding. The tab 20a is adhered to the adhesive 330b of the carrier tape. If desired, the tab may contain a liner on the exposed side, the side closest to substrate 22. If desired, a user may use a squeegee to apply a force (shown schematically as arrow A) thereby firmly bonding the tab to the adhesive. The cover (not shown) is placed on the device such that the bar 318 (see FIG. 24) is proximate to and may touch the some part of the tab 20a. The user turns the crank handle (not shown) thereby causing the third and fourth rollers 323, 324 to move in the direction of indicated by the arrows on the rollers to advance the carrier tape in the direction of arrow B. As the tape carrier moves, it pulls along with it first the tab and then the stretch release adhesive necks down between the two substrates 20, 24 until it completely detaches from both.

While FIG. 26 shows the stretch release adhesive 20 to be a single layer, multiple layer adhesive constructions can be used. Illustrative useful stretch release adhesive includes U.S. Pat. No. 5,989,708 (Kreckel), U.S. application Ser. No. 61/020,423 filed Jan. 11, 2008 and No. 61/036,501 filed Mar. 14, 2008, all of which are incorporated by reference in their entirety.

The carrier tape can be any tape containing an adhesive that adheres to the tab 20a. Illustrate carrier tapes include, e.g., product number 355 and 375, which are packaging tape that are commercially available from 3M Company, St. Paul, Minn.

In one exemplary embodiment, the device has dimensions of 12 inch in length, 6.5 inch in height and 6 inch in width. The platform is generally rectangular in shape having dimensions of 6.125 inch in length and 5 inch in width. Each of the five rollers is cylindrical in shape having a height of about 5 inch. The diameter of each of the roller varies. The surface 328a of the support plate 328 (FIG. 25) has dimensions of 1.25 inch in width and a length of 5 inch. The two sidewalls 313, 314, the base 312, the platform 360, and the support plate can be made of any durable material, such as metals, plastics, and composites thereof. The optional cover 316 can be constructed from clear plastic allowing the user to see the stretch release that is being removed.

Various embodiments of the invention have been described. These and other embodiments are within the scope of the following claims. For example, although many of the figures illustrate adhesive removal devices that hold component 21 such that a major surface of component 21 extends along the x-y plane (orthogonal x-y-z axes are shown, e.g., in FIG. 1), in other embodiments, some of the adhesive removal devices may be modified such that the major surface of component 21 extends along the z-axis direction, as with the embodiments shown in FIGS. 19A-20B. Such an orientation of component 21 may enable gravity to help stretch adhesive layer 20.

We claim:

1. A system comprising:
a first member that holds a component comprising an adhesive layer; and
an adhesive removal member that comprises a rotatable portion that moves the adhesive layer relative to the component.

2. The system of claim 1, wherein the first member defines a wall that engages with at least a portion of the component.

3. The system of claim 1, wherein the first member defines a plurality of compartments, wherein at least two of the compartments have different sizes.

4. The system of claim 1, wherein the first member comprises an arm coupled to a vacuum source, and the arm holds the component with a vacuum force.

5. The system of claim 1, wherein the first member comprises a first holding element configured to engage with a first surface of the component and a second holding element configured to engage with a second surface of the component.

6. The system of claim 1, wherein the rotatable portion of the adhesive removable member defines a surface configured to adhere to at least a portion of the adhesive layer.

7. The system of claim 1 further comprising a cutting member configured to remove adhesive from the adhesive layer that is collected on the adhesive removal member.

8. The system of claim 1, wherein the rotatable portion of the adhesive removal member comprises a mandrel rotatably mounted to a base.

9. The system of claim 1, wherein a first position of the rotatable portion and a second position of the first member are substantially fixed.

10. The system of claim 1, wherein the rotatable portion is movable relative to the first member.

11. The system of claim 1 further comprising a rotation limiting member that limits rotation of the rotatable portion a first direction.

12. The system of claim 1, wherein the rotatable portion of the adhesive removal member comprises a first roller that rotates in a first direction and a second roller that rotates in a second direction substantially opposite the first direction.

13. The system of claim 1 further comprising a knob mechanically coupled to the rotatable portion of the adhesive removal system.

14. The system of claim 1 further comprising the component, the component comprising a substrate, wherein the adhesive layer is at least partially adhered to the substrate, and the portion of the adhesive layer defines a tab protruding from the substrate.

15. The system of claim 1 further comprising a collection member that receives adhesive removed from the component by the adhesive removal member.

16. The system of claim 1, wherein the adhesive removal system comprises a gear track and a gear coupled to the rotatable portion, wherein the gear is configured to engage with the gear track to rotate the rotatable portion.

17. The system of claim 1, wherein the rotatable portion comprises a structured outer surface.

18. The system of claim 1 further comprising a second member that mechanically couples to at least a portion of the adhesive layer, wherein the rotatable portion of the adhesive removable member moves the first member relative to the second member.

19. The system of claim 1 further comprising the component, the component comprising a glass plate and a light crystal display module, wherein the adhesive layer is positioned between the glass plate and the light crystal display module.

20. A device for removing a stretch release adhesive from at least one substrate, the device comprising:
a base having a top surface and opposing first and second edges;
a first side wall disposed on the top surface and along the first edge of the base;
a second side wall disposed on the top surface and along the second edge of the base;
a platform having means for attaching to the first and second side walls and having opposing, front and back edges; and
a support plate disposed proximate to the front edge of the platform,
wherein the combination of the base, the first side wall, the second side wall, and the platform forms a cavity comprising means for supplying a carrier tape to the support plate thereby allowing the stretch release tape to engage with the carrier tape.

21. The device of claim 20, wherein on a top surface of the platform, the device further comprises at least one of the following features (i) a recess disposed thereon and ending near the front edge and (ii) an aperture disposed centrally thereon.

22. The device of claim 20, wherein the means for attaching to the first and second side walls includes pins disposed along opposing lateral edges of the platform, the pins engageable with at least one of the following features (i) a first groove disposed on a back edge of each of the first and second side wall and (ii) a notch disposed on a top edge of each of the first and second side wall.

23. The device of claim 20, wherein the means for supplying the carrier tape to the support plate comprises the following features attached to and between the first and second side walls (i) a first roller disposed near the back edge for mounting a roll of carrier tape, (ii) a fifth roller disposed near the front edge for taking up the carrier tape and the stretch release adhesive after it has been removed from the substrate, (iii) and second, third, and fourth rollers disposed between the first and fifth rollers for conveying the carrier tape therebetween.

24. The device of claim 23, wherein the second and third rollers are disposed between the first roller and the support plate and the fourth roller is disposed between the support plate and the fifth roller.

25. The device of claim 23, wherein the carrier tape comprises an adhesive disposed on a backing and the carrier tape path from the first unwind roller through fifth take-up roller is such that as the carrier tape is unwound from the first roller, the backing of the carrier tape contacts a portion of the circumference of the second roller, the support plate, and a portion of the circumference of the fourth roller and the adhesive of the carrier tape contacts a portion of the circumference of the third roller, which circumference does not adhere to the adhesive.
